(19) United States
(12) Patent Application Publication
(10) Pub. No.: US 2014/0054651 A1
(43) Pub. Date: Feb. 27, 2014

(54) RELIABLE NANOFET BIOSENSOR PROCESS WITH HIGH-K DIELECTRIC

(71) Applicants: Rashid Bashir, Champaign, IL (US); Bobby Reddy, Savoy, IL (US); Brian Ross Dorvel, Champaign, IL (US)

(72) Inventors: Rashid Bashir, Champaign, IL (US); Bobby Reddy, Savoy, IL (US); Brian Ross Dorvel, Champaign, IL (US)

(73) Assignee: The Board of Trustees of the University of Illinois, Urbana, IL (US)

(21) Appl. No.: 13/992,217

(22) PCT Filed: Nov. 18, 2011
(86) PCT No.: PCT/US11/61524

§ 371 Date: Nov. 6, 2013

Related U.S. Application Data
(60) Provisional application No. 61/420,872, filed on Dec. 8, 2010.

(51) Int. Cl. G01N 27/414

(52) U.S. Cl. CPC G01N 27/4145
USPC 257/253; 438/49

(57) ABSTRACT

Provided are semiconductor field effect sensors including a high-k thin film gate dielectric. The semiconductor field effect sensors described herein exhibit high detection sensitivity and enhanced reliability when placed in contact with liquids. Also disclosed are semiconductor field effect sensors having optimized fluid gate electrode voltages and/or back gate electrode voltages for improved detection sensitivity.

### CROSS REFERENCE TO RELATED APPLICATION

This application claims the benefit of and priority to U.S. Provisional Application 61/420,872, filed on Dec. 8, 2010, which is hereby incorporated by reference in its entirety.

### STATEMENT REGARDING FEDERALLY SPONSORED RESEARCH OR DEVELOPMENT

This invention was made with United States governmental support under Award No. R01CA20003 awarded by the National Institutes of Health. The U.S. government has certain rights in the invention.

### BACKGROUND

This invention is in the field of chemical- and biological-sensors. This invention relates generally to field effect sensor devices incorporating a high-k dielectric layer to provide enhanced sensitivity and robustness.

Silicon based biosensors have proven to be extremely useful tools for a variety of bio-analytical applications. After the first introduction of the adaption of a standard Metal-Oxide-Semiconductor Field Effect Transistor (MOSFET) for physiological measurements in 1970 and the initial demonstration of the detection of pH, ISFETs have been used for a variety of other applications, such as the detection of various proteins, the indication of immunological reactions, and the monitoring of cell activity. The physics of sensor operation have been well studied, and detailed analytical models combining electrochemical theory of electrodes in fluid with standard semiconductor theory have been developed. A landmark report in 2001 first demonstrated bottom-up nanowires as FETs that could be used as ultrasensitive, label-free sensors of both buffer pH and proteins in a fashion similar to previously used ISFET sensors. The demonstrated sensitivities were much higher than counterpart ISFET sensors (down to 10 pM for streptavidin), and are generally attributed to the reduced dimensionality of devices to sizes on the order of the biomolecules to be detected. Since 2001, a plethora of work has shown detection of various molecules and processes, including DNA, miRNA, PNA, cancer biomarkers, viruses, neuronal signals, and cell response to various stimuli. In addition, a host of parameters have been varied and examined including top down or bottoms up fabrication, AC versus DC measurement schemes, use of a fluid gate or lack thereof, use of a backgate, the operation of devices in accumulation or inversion mode, etc. Focused efforts have been made to determine the effect of the ionic strength of the buffer, the effect of charge distance from the surface, the effect of biasing voltages, and the effect of device width.

### SUMMARY

In a first aspect, provided are semiconductor field effect sensors. An embodiment of this aspect comprises a source region, a drain region, a channel region positioned between the source and drain regions, a buried back gate positioned at least partly below the channel region; a sensing region positioned over the channel region, the sensing region comprising a high-k dielectric layer; a fluid positioned in contact with the sensing region; and a fluid gate electrode positioned in contact with the fluid. Contemplated embodiments include where the sensor comprises a nanowire, a nanoplate or both a nanowire and a nanoplate.

In a specific embodiment, the sensor is electrically stable when the fluid is in contact with the sensing region. For example, the sensor is electrically stable when the fluid is in contact with the sensing region for a period greater than 1 minute, a period greater than 30 minutes, a period greater than 1 day, a period greater than 1 week, a period greater than 1 month or a period greater than 10 months.

In embodiments, a leakage current from components of the sensor are limited by the sensor construction. For example, in one embodiment, a leakage current between the source region and the back gate, between the drain region and the back gate or between the channel region and the back gate is insufficient to permanently damage the sensor. In an embodiment, a leakage current between the source region and the fluid, between the drain region and the fluid or between the channel region and the fluid is insufficient to permanently damage the sensor. Useful maximum leakage currents include 1 μA, 0.1 μA, or selected over the range of 1 μA to 0.01 μA.

In a specific aspect, the high-k dielectric layer has a thickness selected over the range of 0.1 nm-10 μm. In an embodiment, the high-k dielectric layer is deposited over the channel region using atomic layer deposition. Useful high-k dielectrics include, but are not limited to, Al₂O₃, HfO₂, ZrO₂, HfSiO₄, ZrSiO₄ and any combination of these.

In embodiments, the source and drain regions independently comprise doped semiconductors. In one embodiment, the sensor further comprises a semiconductor oxide layer positioned between the channel region and the high-k dielectric layer. Optionally, a sensor further comprises a metal layer positioned over at least a portion of the high-k dielectric layer. Useful metal layers include those comprising aluminum, platinum and/or gold. In embodiments, the metal layer has a thickness selected over the range of 0.1 nm-100 μm.

In exemplary embodiments, the back gate is biased relative to the source region or the drain region at a voltage selected over the range of −20 V to 20 V, for example selected over the range of −10 V to 4 V. Optionally, the fluid gate electrode is biased relative to the source region or the drain region at a voltage selected over the range of −20 V to 20 V, for example selected over the range of −6 V to 6V. Useful fluid gate electrodes include but are not limited to those comprising Pt, Ag, AgCl or any combination of these.

Also provided are chemical sensor arrays. An embodiment of this aspect comprises a plurality of sensors, for example a plurality of those described above. For some embodiments of this aspect, each of the plurality of sensors are independently electrically addressable. For some of the embodiments of this aspect, each of the plurality of sensors are independently fluidly addressable.

Also provided are methods for sensing a compound using a field effect sensor. A method of this aspect comprises, providing a field effect sensor, such as any of those described above; monitoring an electrical property of the channel region; providing the compound to fluid in contact with a sensing region of the field effect sensor; and determining a change in the electrical property of the channel region of the field effect sensor due to the presence of the compound in the fluid, thereby sensing the compound.

Also provided are lab-on-a-chip devices. A device of this aspect comprises a field effect sensor, such as any of those described above; and one or more sensing, amplifying, heating or concentrating regions positioned in fluid communication with the sensor.

Also provided are methods of making a chemical sensor. A method of this aspect comprises the steps of: providing a semiconductor wafer, wherein the semiconductor wafer comprises a semiconductor substrate layer, a buried oxide layer and a superficial semiconductor layer, wherein the buried oxide layer is positioned between the semiconductor substrate layer and the superficial semiconductor layer; masking at least a portion of the superficial semiconductor layer with a first mask; etching at least a portion of the superficial semiconductor layer, thereby forming an etched semiconductor layer; removing the first mask; masking at least a portion of the etched semiconductor layer with a second mask; implanting at least a portion of the etched semiconductor layer with dopants, thereby creating doped source and drain regions and undoped channel regions in the etched semiconductor layer; and depositing a high-k dielectric layer over the channel regions using atomic layer deposition.

A specific embodiment of this aspect further comprises the steps of: patterning electrodes in independent electrical communication with each source and drain region; depositing a dielectric passivation layer over at least a portion of the high-k dielectric layer and over at least a portion of the electrodes; and etching a portion of the dielectric passivation layer to expose a portion of the high-k dielectric layer.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 provides an overview of a field effect sensor device and scanning electron micrograph images of various views of a field effect sensor device.

FIG. 2 provides an overview of the operation of a field effect sensor device and provides voltage and current data for an operating device embodiment.

FIG. 3 provides an overview of a field effect sensor with a biased backgate and provides data showing electrical parameters thereof.

FIG. 4 provides data comparing pH sensitivities of field effect sensor devices comprising Al₂O₃ and SiO₂ gate dielectrics.

FIG. 5a provides an overview of nanoplate and nanowire field effect sensor devices at two different debye lengths. FIGS. 5b and 5c provide data showing a comparison between field effect sensor devices comprising Al₂O₃ and SiO₂ gate dielectrics.

FIG. 6 provides scanning electron micrograph images of field effect sensors.

FIG. 7 provides optical images showing various aspects of an experimental measurement setup for sensing pH using a field effect sensor device.

FIG. 8 provides voltage plots establishing threshold voltage shifts.

FIG. 9 provides an overview of nanowire and nanoplate sensor devices with a fluid gate electrode.

FIGS. 10-51 provide process flow diagrams for various steps of fabricating nanowire and nanoplate field effect sensor devices.

### DETAILED DESCRIPTION

In general the terms and phrases used herein have their art-recognized meaning, which can be found by reference to standard texts, journal references and contexts known to those skilled in the art. The following definitions are provided to clarify their specific use in the context of the invention.

“Field effect sensor” refers to a semiconductor device, similar to a field effect transistor, in which the conductivity of a channel in the semiconductor is modified by the presence of analyte molecules near the surface of a sensing region.

“Nanoplate” refers to a sensing region of a field effect sensor having a specific shape, for example a planar or substantially planar and rectangular shape.

“Nanowire” refers to a sensing region of a field effect sensor having a specific shape, for example a cylindrical or substantially cylindrical shape, similar to that of a wire.

“PCR” or “Polymerase chain reaction” refers to the well-known technique of enzymatic replication of nucleic acids which uses thermal cycling for example to denature, extend and anneal the nucleic acids.

“Loading” or “loaded” refers to providing a molecule, compound, substance or structure to the sensing region or a well adjacent to or above the sensing region of a chemical sensor device.

“Semiconductor” refers to any material that is an insulator at very low temperatures, but which has an appreciable electrical conductivity at a temperature of about 300 Kelvin. In the present description, use of the term semiconductor is intended to be consistent with use of this term in the art of microelectronics and electrical devices. Useful semiconductors include element semiconductors, such as silicon, germanium and diamond, and compound semiconductors, such as group IV compound semiconductors such as SiC and SiGe, group III-V semiconductors such as AlSb, AlAs, Aln, AlP, BN, GaSb, GaAs, GaN, GaP, InSb, InAs, InN, and InP, group III-V ternary semiconductors alloys such as AlₓGa₁₋ₓAs, group II-VI semiconductors such as CsSe, CdS, CdTe, ZnO, ZnSe, ZnS, and ZnTe, group I-VII semiconductors CuCl, group IV-VI semiconductors such as PbS, PbTe and SnS, layer semiconductors such as PbI2, MoS2 and GaSe, oxide semiconductors such as CuO and Cu2O.

The term semiconductor includes intrinsic semiconductors and extrinsic semiconductors that are doped with one or more selected materials, including semiconductor having p-type doping materials (also known as P-type or p-doped semiconductor) and n-type doping materials (also known as N-type or n-doped semiconductor), to provide beneficial electrical properties useful for a given application or device. The term semiconductor includes composite materials comprising a mixture of semiconductors and/or dopants. Useful specific semiconductor materials include, but are not limited to, Si, Ge, SiC, AlP, AlAs, AlSb, GaN, GaP, GaAs, GaSb, InP, InAs, GaSb, InP, InAs, InSb, ZnO, ZnSe, ZnTe, CdS, CdSe, ZnSe, ZnTe, CdS, CdSe, CdTe, HgS, PbS, PbSe, PbTe, AlGaAs, AlInAs, AlInP, GaAsP, GaInAs, GaInP, AlGaAsSb, AlGaInP, and GaInAsP. Porous silicon semiconductor materials are useful in the field of sensors and light emitting materials, such as light emitting diodes (LEDs) and solid state lasers. Impurities of semiconductor materials are atoms, elements, ions and/or molecules other than the semiconductor material(s) themselves or any dopants provided to the semiconductor material. Impurities are undesirable materials present in semiconductor materials which may negatively impact the electrical properties of semiconductor materials, and include but are not limited to oxygen, carbon, and metals including heavy metals. Heavy metal impurities include, but are not limited to, the group of elements between copper and lead on the periodic table, calcium, sodium, and all ions, compounds and/or complexes thereof.

“Leakage current” or “leakage” refers to electric current which flows from an electronic device along an unintended path. Under certain conditions, leakage of sufficient current from an electronic device can damage the device and/or components thereof. In certain circumstances, leakage current can also or alternatively damage the material into which it flows.

“Substrate” refers to a material having a surface that is capable of supporting a component, including a device, component or layer.

“Dielectric” refers to a non-conducting or insulating material. In an embodiment, an inorganic dielectric comprises a dielectric material substantially free of carbon. Specific examples of inorganic dielectric materials include, but are not limited to, silicon nitride, silicon dioxide. A “high-k dielectric” refers to a specific class of dielectric materials, for example in one embodiment those dielectric materials having a dielectric constant larger than silicon dioxide. In some embodiments, a high-k dielectric has a dielectric constant at least 2 times that of silicon dioxide. Useful high-k dielectrics include, but are not limited to Al₂O₃, HfO₂, ZrO₂, HfSiO₄, ZrSiO₄ and any combination of these.

The invention may be further understood by the following non-limiting examples.

### EXAMPLE 1

### Fabrication and Characterization of Nanowire and Nanoplate Field Effect pH Sensors

Over the last decade, field-effect transistors (FETs) with nanoscale dimensions have emerged as possible label-free biological and chemical sensors capable of highly sensitive detection of various entities and processes. While significant progress has been made towards improving their sensitivity, much is yet to be explored in the study of various critical parameters, such as the choice of a sensing dielectric, the choice of applied front and back gate biases, the design of the device dimensions, and many others. This example presents a process to fabricate nanowire and nanoplate FETs with Al₂O₃ gate dielectrics and compares these devices with FETs with SiO₂ gate dielectrics. The optimized process results in devices which are stable for up to 8 hours in fluidic environments. Using pH sensing as a benchmark, the importance of optimizing the device bias is shown, particularly the bulk bias which modulates the effective channel thickness. This example also demonstrates that devices with Al₂O₃ gate dielectrics exhibit superior sensitivity to pH when compared to devices with SiO₂ gate dielectrics. Finally, it is shown that when the silicon channel thickness is on the order of the Debye length, 50 nm wide nanowire devices and 2 μm wide nanoplate devices exhibit similar response to changes in pH.

This example uses pH sensing as a benchmark to understand the effect of three parameters on the device performance using experimental results and supporting simulations—the employed gate dielectric, the use of a backgate, and the device width. The presented device fabrication process allowed for direct comparisons of Al₂O₃ versus SiO₂ gate dielectrics of the same thicknesses, for optimization of the backgate bias condition to lower the effective electrical thickness of the device, and for comparison of devices with identical characteristics except for differing widths on the same chip. The devices are demonstrated to be stable and operate in fluidic environments for up to 8 hours, quantified by threshold voltage stability and leakage current characterization.

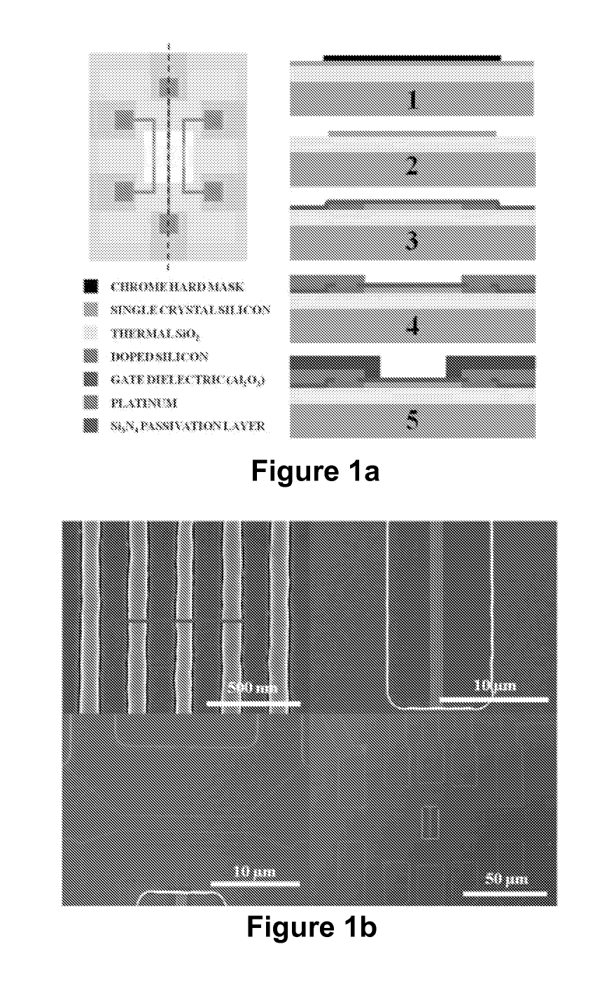

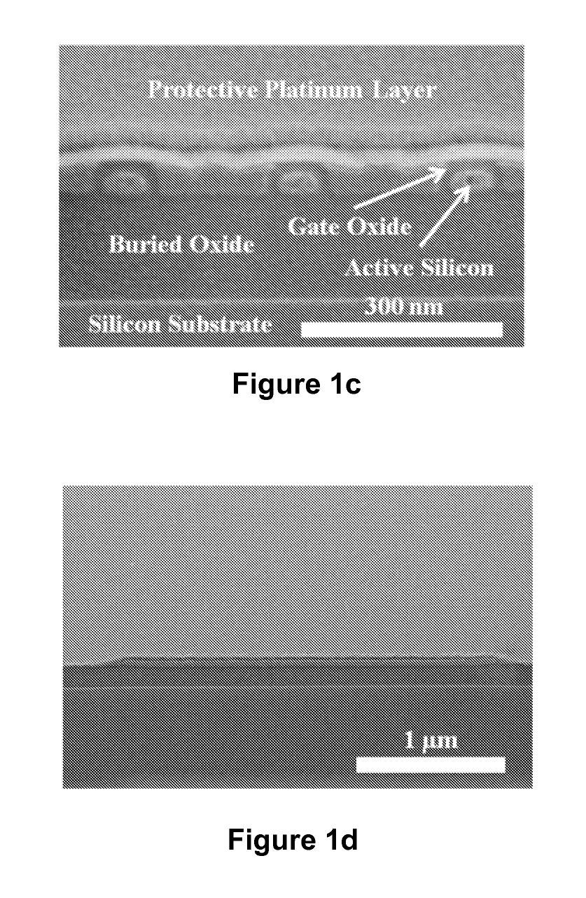

Top down fabrication was utilized to create the silicon nanoFET devices. For details, please see below. Briefly, the fabrication flow began with bonded Silicon on Insulator (SOI) wafers, doped p type at 10¹⁵/cm² with a buried oxide thickness of 1450 Å and top silicon thickness of 550 Å. After dry oxidation and subsequent wet oxide etch to thin down the top silicon layer to approximately 300 Å, electron beam lithography was used to define the nanowires and other small features, followed by liftoff of chrome to form the first hard mask. Next, optical lithography was used to define all of the larger features, such as the nanoplates and mesas to make contact to the nanowires. After another chrome evaporation and liftoff, the entire hard mask over the active silicon layer was complete (FIG. 1a, part 1). Next, the active silicon layer was formed by wet etching away the top silicon with TMAH using the chrome patterns as a hard mask (FIG. 1a, part 2). After doping the source and drain regions with boron (simulated doping ˜10¹⁹/cm³), the fabrication process was split to form different gate dielectrics. For silicon dioxide devices, the device was dry oxidized to controllably grow ˜150 Å thick SiO₂. For aluminum oxide devices, the device was deposited with 75 cycles of atomic layer deposition (ALD) Al₂O₃, which results in ˜150 Å thick Al₂O₃ (FIG. 1a, part 3). At this point, any dielectric that can be deposited using an ALD process can be employed instead of aluminum oxide. Following the gate dielectric formation, the devices were annealed in forming gas to remove interface states. Via holes were etched into contact regions, and 250 Å/750 Å thick titanium/platinum was patterned to make contact to the source and drain regions of the devices (FIG. 1a, part 4). A rapid thermal anneal was then performed at 550° C. in a N₂ environment to reduce the contact resistance at the source and drain regions of the devices. Next, a 4000 Å thick passivation layer of PECVD nitride was deposited over the entire wafer. Optical lithography and a dry CF₄ RIE etch were then used to etch the passivation layer directly over the device active area (FIG. 1a, part 5). Al₂O₃ serves as an excellent etch stop during this etch back (etch selectivity of 60:1 for Si₃N₄:Al₂O₃), allowing for a uniform and well characterized etchback step. For SiO₂ devices, the etchback step needed to be timed carefully to ensure that the top gate SiO₂ was not damaged. During this step, the passivation layer over a platinum electrode close to the devices was also etched to expose the on-chip fluid gate. Top view SEMs of the devices are shown in FIG. 1b, including zoomed in views of patterns of silicon nanowires, mesas used to connect to the devices, the etchback window to expose the devices, and the metal interconnects used to make the electrical contact. Cross sectional SEMs of both wire devices (FIG. 1c) and plate devices (FIG. 1d) show good insulation quality, which contributes to the stability of the devices in fluid.

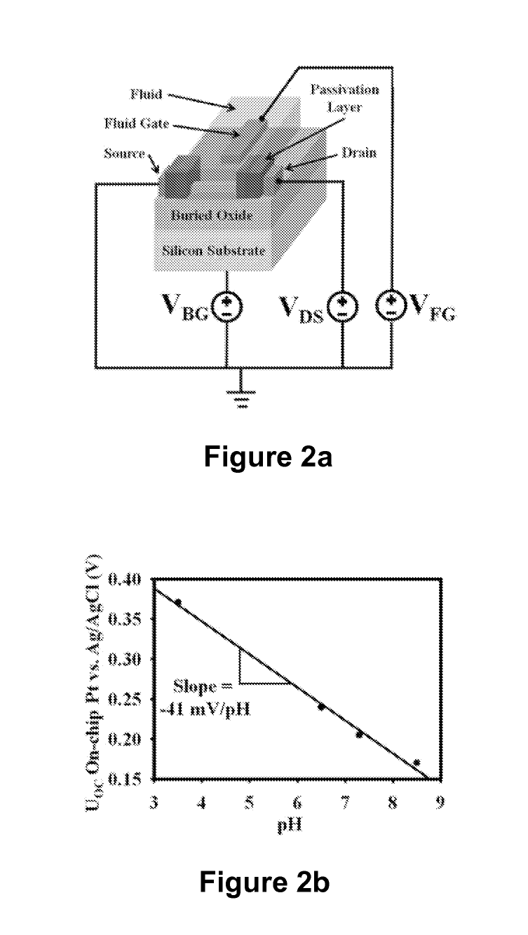

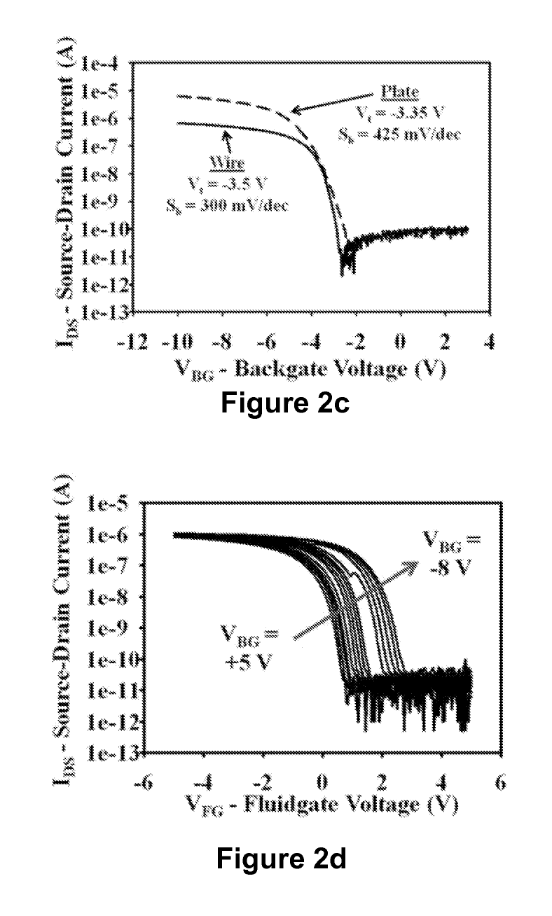

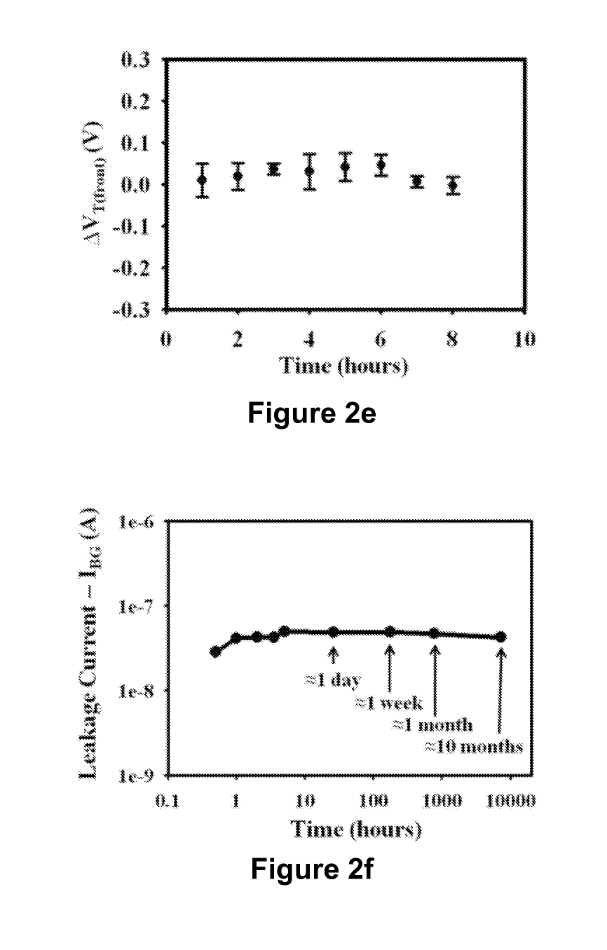

The schematic used for electrical testing of the devices is shown in FIG. 2a. A constant potential is applied between the source and drain, and the current between these nodes is measured as either the backgate voltage or the fluid gate voltage is swept. The fluid gate voltage is applied via an onchip platinum pseudo reference electrode that was patterned as part of the metallization step during fabrication. Because platinum is known to have a pH-dependent Fermi level, the open circuit potential between the platinum electrode and a reference Ag/AgCl electrode was measured in Robinson buffers of various pH values with 10 mM of KCl. A linear decrease of about 41 mV/pH was observed in the open circuit potential of the fluid gate, which can be viewed as additional sensitivity of the devices to pH. However, all figures referred to in this example have been corrected for this effect, by subtracting the raw threshold voltage shifts by 41 mV per pH, and hence solely reflect surface potential shifts of the FET devices.

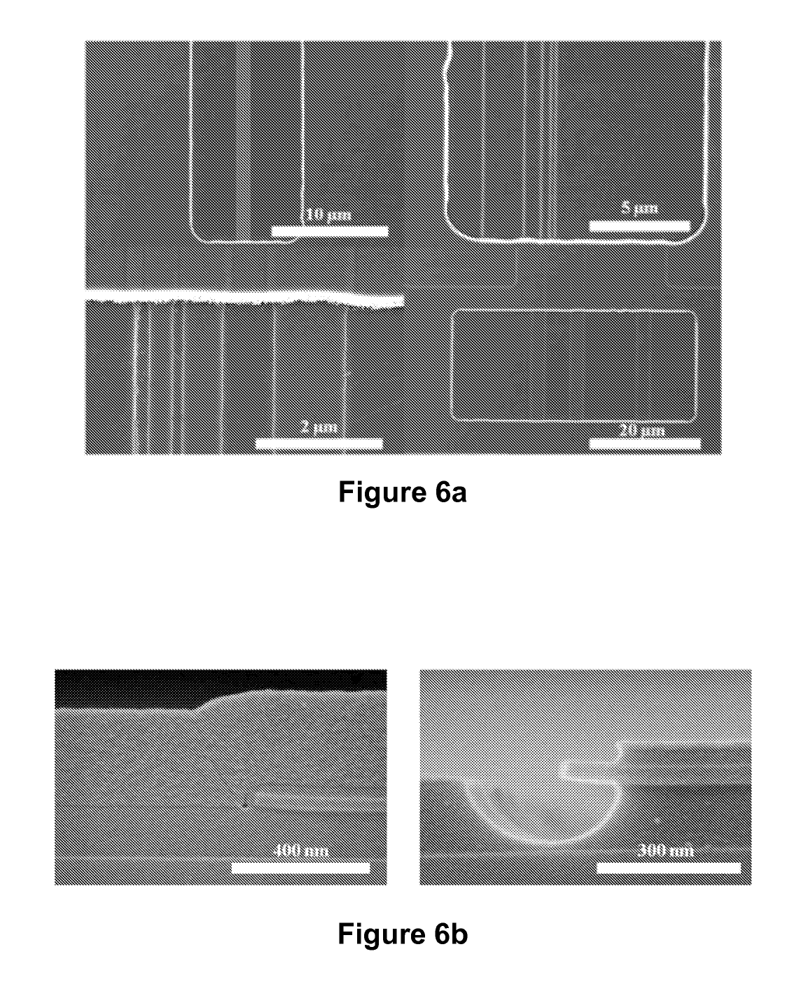

Initial Al₂O₃ device characterization was performed in air (without fluid on the devices) utilizing the backgate (VBG in FIG. 2a). Both 50 nm wide nanowire devices and 2 μm wide nanoplate devices showed normal transistor behavior as the drain source current (IDS) was measured while the backgate voltage was varied (FIG. 2c). Next, the devices were placed in a 0.01× Phosphate Buffered Saline (PBS) solution to measure the characteristics in fluid. The fluid gate voltage (VFG) was swept from −5 to +5 V for backgate biases from +5 to −8 V (FIG. 2d). This demonstrates full double gate operation of the device; device current is modulated effectively by the fluid gate, and the different back gate biases correspond to shifts in the threshold voltage of the IDS-VFG curves. Very similar characteristics were observed with SiO₂ devices, as described below. Shifts in threshold voltage (of the IDS-VFG curves) were used for most experiments as a measure of changes in surface potential of the silicon to allow for comparisons that minimized the effect of device to device variation. To determine the minimum observable shift in threshold voltage that could be considered real, the representative noise was quantified by measuring the threshold voltage of five Al₂O₃ nanowire devices as a function of time for up to 8 hours, which is much longer than any typical experiment should take. The devices showed excellent threshold voltage stability over 8 hours in fluid (FIG. 2e), and also showed minimal changes in leakage currents even when tested over 10 months where the same device was exposed to fluid for about 30 minutes for each measurement (FIG. 2f). This device stability can be attributed to the proper protection of the electrical components from fluid with the silicon nitride insulating film as shown from the cross sections of the device (FIGS. 1c, 1d, and FIG. 6b). From the minimal threshold voltage drift, the minimum detectable change in threshold voltage for this system was found to be is around 50 mV; any shifts in the raw data below this amount were not considered to be numerically significant.

The devices were first used to demonstrate the utility of the back gate during sensing. Recent reports singled out the careful tuning of the applied fluid gate bias to place devices in the subthreshold regime as a useful tool for maximizing the sensitivity of both pH and protein detection. Fundamentally, the Debye length can be varied in the silicon channel. The Debye length dictates how far electric fields will penetrate into the silicon channel and is given by λ_{Si}=(ε_{Si}ε₀k_{B}T/ρq²)^{1/2}, where ε_{Si} is the dielectric constant of silicon, ε₀ is the permittivity of free space, k_{B} is the Boltzmann constant, ρ is the net charge density, and q is the elemental charge (˜1-2 nm for ρ=10¹⁸-10¹⁹ cm⁻³). In response to charge modulation at the gate dielectric/fluid interface due to pH or protein binding events, changes in carrier concentration in the channel will occur principally within a Debye length away from the gate dielectric/silicon interface. By using the applied bias to reduce the net charge in the channel, the Debye length is increased, allowing for a higher percentage of the silicon channel to feel changes in charge at the surface, leading to increased sensitivity.

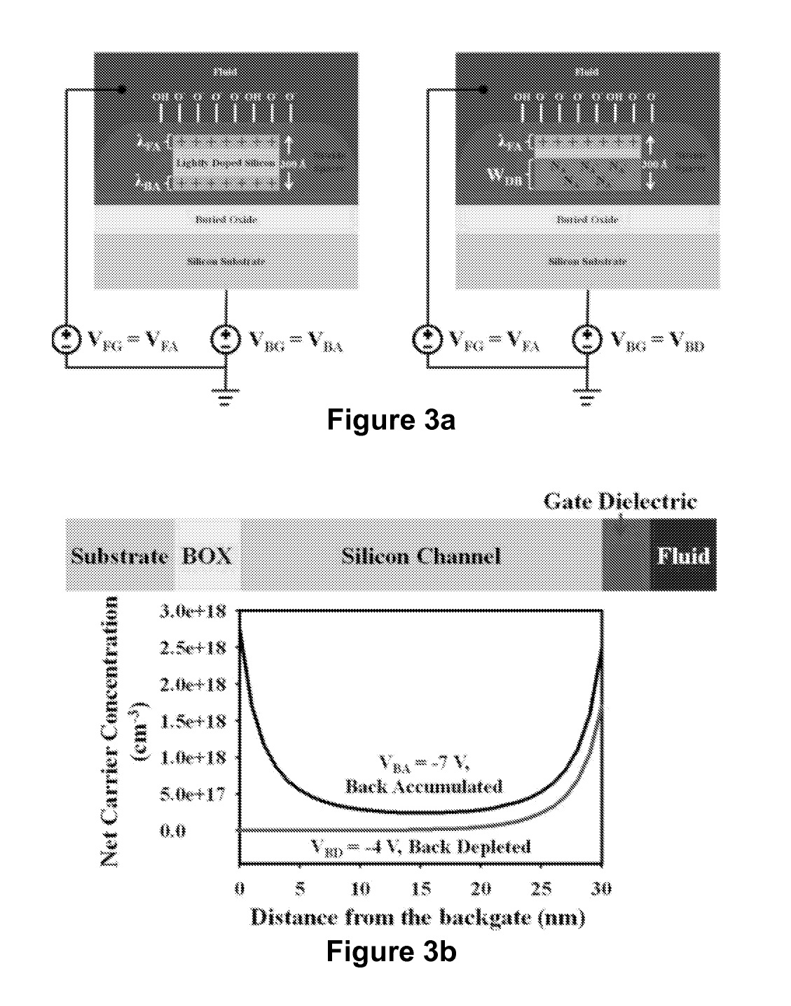

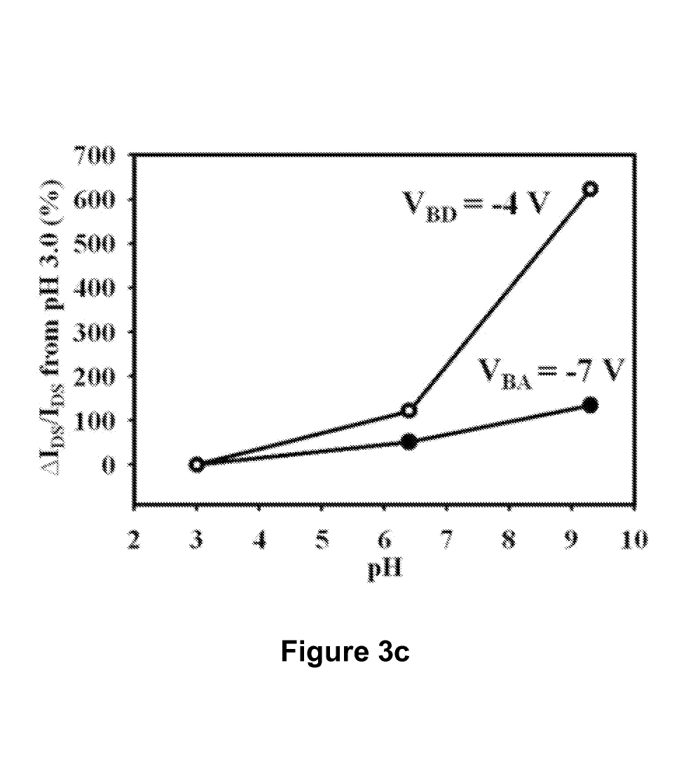

This example shows that the applied back gate bias can be similarly utilized to modulate the effective electrical device thickness. The concept is analogous to accumulation mode fully depleted double-gated SOI MOSFETs, and is illustrated schematically in FIG. 3a. Assuming that the front gate has been biased to place the top part of the channel into accumulation, changes in surface charge will only be felt a few nanometers into the top surface of the channel. If the back gate is biased to put the back of the channel into accumulation (VBA<−5 V for most of the devices described in this example), then a significant part of the 30 nm thick channel will conduct current that is insensitive to changes in surface charge (FIG. 3a, left). Alternatively, if the back gate has been biased such that the channel is depleted except for the top accumulated surface (FIG. 3a, right), the effective electrical thickness of the device has now been reduced to the order of a few nanometers. In this case, changes in surface charge directly influence the entire electrically active area of the channel, which will lead to increased sensitivity. The physical thickness of the device, at 30 nm, is much less than the theoretical maximum achievable depletion width for a 10¹⁵ p-type doped channel (˜800 nm). Medici, a 2D device simulation tool, was used to simulate the net carrier concentration as a function of the vertical position in the channel (FIG. 3b), with an applied front gate voltage of VFG=−1 V and two different back gate voltages, VBG=−7 V and −4 V. A silicon surface carrier concentration on the order of 10¹⁸ at the top channel/gate dielectric interface was simulated for both back gate accumulated and depleted. However, when the back silicon was accumulated, an additional channel forms at the back gate which will be insensitive to charge changes at the front, thus reducing overall sensitivity. The expected trends were then confirmed experimentally. Selection of the appropriate buffer for use during pH experiments is very important. Robinson solutions (1 mM acetic, 1 mM phosphate, and 1 mM boric with titrated HCl/NaOH to obtain the desired pH) were used because of the capacity as a universal buffer to maintain pH over a large range of pH values. In addition, all solutions were measured after the experiment to confirm that the solutions maintained the pH values that were plotted. As the solutions slowly flowed over the surface of the 50 nm wide SiO₂ devices, drain source current was measured as a function of applied fluidic gate bias at two fixed back gate biases to put the back silicon first in accumulation then depletion. An example of a typical result is shown in FIG. 3c, at an applied fluid gate of VFG=1.5 V. When the back silicon was placed into accumulation, at VBA=−4 V, a distinct increase in current of around 100% of the original value was observed when varying the pH from 3.0 to 9.3. However, when the back was placed into depletion (VBD=−7 V), a far higher change was observed: up to 600% increase in current, which matches the predictions of the Medici simulations.

Next, the performance of devices with Al₂O₃ gate dielectric were compared against those having SiO2 gate dielectric, which has been traditionally used in nanoscale field effect biosensors. Al₂O₃ is expected to have greater sensitivity than SiO₂. The change in channel charge resulting from changes at the oxide/fluid interface is given by:

$${Δσ}_{silicon} = - {C}_{D} {Δψ}_{0} \approx - \frac{{ɛ}_{D} {ɛ}_{0}}{{t}_{D}} {Δψ}_{0}$$

where C_{D} is the dielectric capacitance, Δψ₀ is the change in surface potential at the oxide/fluid interface, E_{D} is the dielectric constant of the gate dielectric (3.9 and 9 for SiO₂ and Al2O₃, respectively), and t_{D} is the thickness of the dielectric. Thus, the change in charge in the silicon (which translates directly to changes in current) is linearly proportional to the dielectric constant. Furthermore, when biosensor device sensitivity is defined as S=ΔG/G₀, device sensitivity is also linearly proportional to ε_{D}, and can be written as:

$$S = \frac{2 {ɛ}_{D} {ɛ}_{0} {ψ}_{0} N ( t )}{q {a}^{2} {N}_{D} log ( 1 + \frac{{t}_{D}}{a} )}$$

where N(t) is the density of charge states at the surface, a is a geometry parameter, and N_{D} is the doping of the silicon. In addition, for pH sensing, the change in surface potential for an ISFET sensor (which is directly relevant here) is given by:

$${Δψ}_{0} = \frac{- 2.3 \frac{RT}{F} Δ pH}{( \frac{2.3 k T}{{q}^{2}} ) ( \frac{{C}_{s}}{{β}_{s}} ) + 1}$$

where Cₛ is the differential double layer capacitance (dependent mostly on the ion concentration of the solution) and βₛ is the buffer capacity of the surface, which is known to be markedly higher for Al₂O₃ when compared to SiO₂.

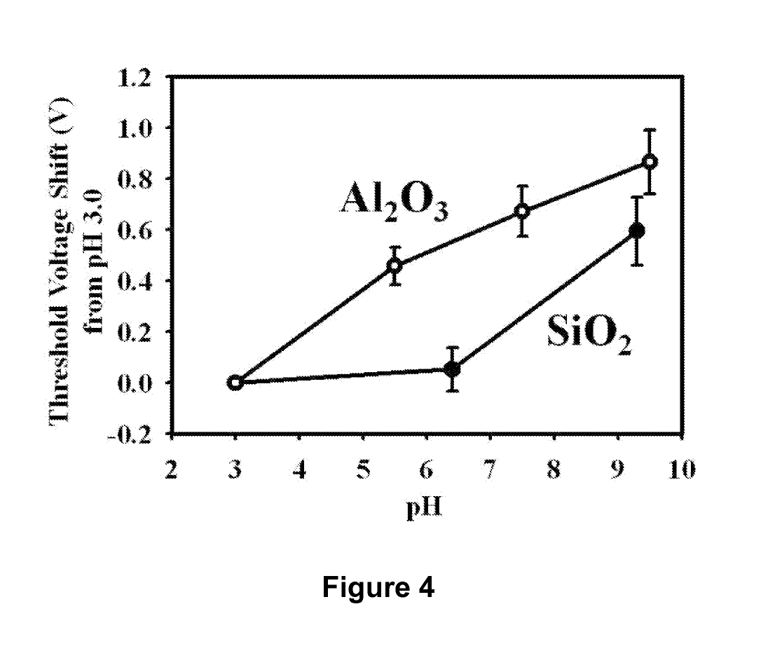

A side by side comparison of the silicon dioxide and the aluminum oxide devices was performed. The devices were optimized for back gate biasing conditions, and were placed into the Robinson buffer solutions of varying pH. At each pH, IDS was measured as a function of VFG for a constant VBG. The threshold voltage for each curve was extracted using a constant current method. Results for three Al₂O₃ and three SiO₂ devices, all 50 nm in width and 30 nm thick, are shown in FIG. 4. The observed average sensitivity of threshold voltage shift per pH is approximately 1.4 times higher for the Al₂O₃ devices when compared to the SiO₂ devices, which is slightly higher than reported comparisons for ISFET devices, around 1.314.

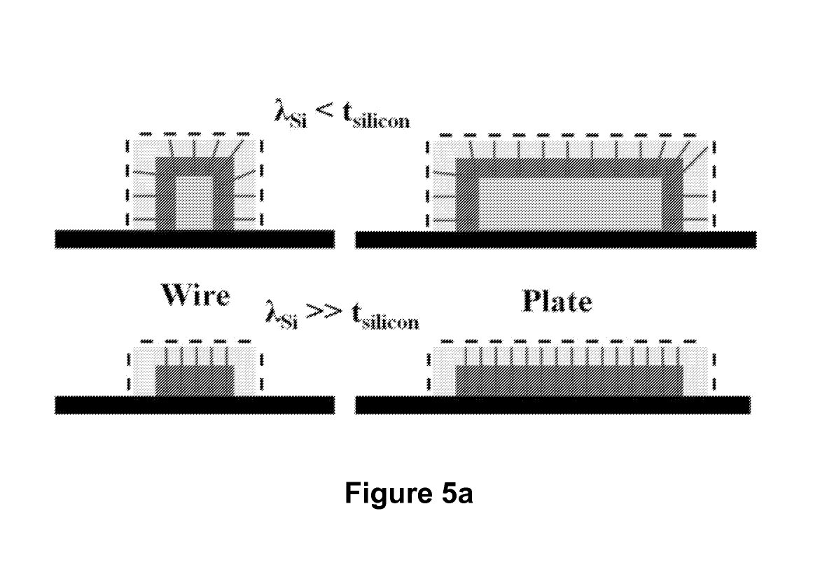

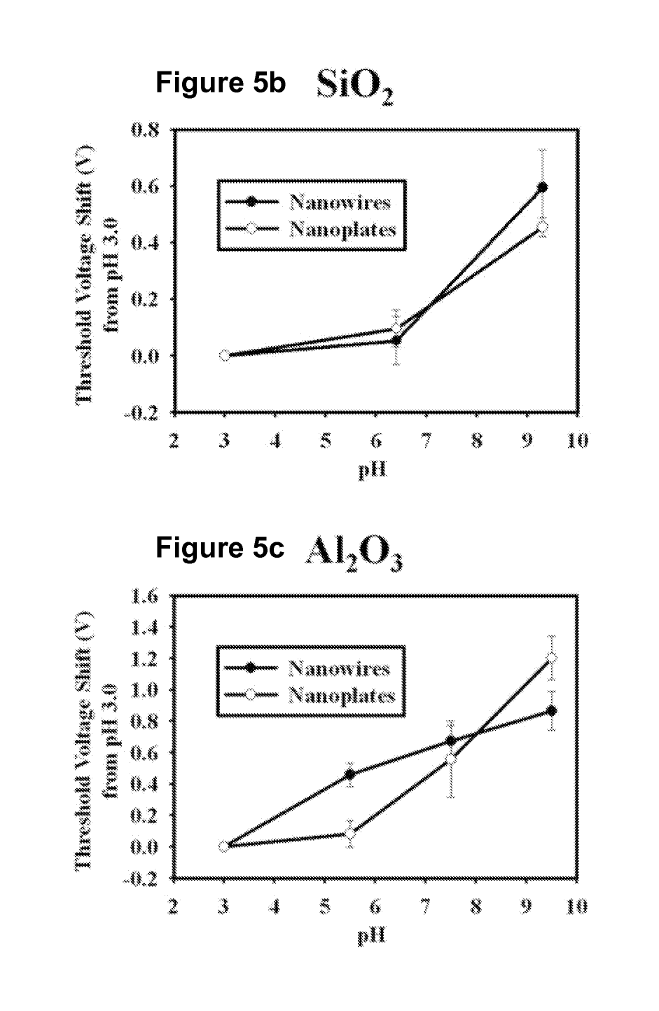

Both the Al₂O₃ and SiO₂ devices were next employed to investigate the effect of device width on sensitivity of pH detection. It was found that devices with a physical thickness of 30 nm and a width of either 50 nm (nanowires) or 2 μm (nanoplates) showed very similar responses to changes in pH. This is explained conceptually in FIG. 5a. When the thickness of the devices is much larger than the silicon Debye length (top) as previously reported, changes in charge at the surface affect a much larger percentage of the cross-section of the device channel for a wire configuration (left) as compared to a plate (right), thus resulting in higher responses for the wire as compared to the plate. This is due primarily to the exposure of the sidewalls of a nanowire device, which allow for more of the channel charge to be modulated by the sidewall. However, for our devices, after backgate optimization, the effective electrical channel thickness is much smaller or on the same order as the silicon Debye length (FIG. 5a, bottom). Changes in charge at the top surface affect the entire channel regardless of whether a nanowire or a nanoplate is used to measure response. In this case, very little dependence of sensitivity or response is expected on device width. This trend was observed experimentally for both gate dielectrics, by flowing Robinson buffers of different pH values over 50 nm wide nanowires and 2 μm wide nanoplates patterned on the same chip in close proximity (with 500 um of each other). Results are plotted in FIG. 5a for SiO₂ devices and FIG. 5b for Al₂O₃ devices. It is clear from the observed response of the devices was relatively independent of device width.

In summary, this example explores critical parameters that could be used to optimize the sensing of pH changes by field effect sensors and demonstrates a top-down fabrication process that incorporates a new dielectric material, Al₂O₃, suggesting the possibility that a wide variety of other high k-dielectrics can also be utilized in nanowire field effect sensors. Both the Al₂O₃ and SiO₂ devices showed normal stable transistor operation. By applying a potential to the back gate we were able to thin the effective electrical thickness of the devices to a few nanometers, which dramatically increases the response of the devices. The Al₂O₃ devices outperformed their counterpart SiO₂ devices by an average sensitivity improvement of 1.42, matching theoretical expectations. Lastly, an on-chip comparison of 50 nm wide nanowire devices and 2 μm wide nanoplate devices showed that when the effective device thickness is on the order of the silicon Debye length, response to changes in pH is independent of device width.

EXPERIMENTAL SECTION. Device Fabrication. The devices were fabricated using top down fabrication, starting with bonded SOI wafers, with the following steps: 1) 8″ bonded SOI wafers (SOITECH) doped p-type at 10¹⁵/cm² with BOX thickness of 145 nm and superficial silicon thickness of 55 nm were laser cut into 4″ wafers by Ultrasil Corp. 2) Wafers were oxidized for 11 minutes at 1000° C. to grow 30 nm of oxide and placed into buffered oxide etch (BOE) to thin down the top silicon to around 350 Å. 3) A double layer resist strategy was used with 100 nm/95 nm of LOR 1A/PMMA to define the smaller patterns (the 50 nm nanowires and connections) using electron beam lithography, with dosages varying from 1700 μC/cm² to 2000 μC/cm² for the different designed patterns. The wafers were then placed into 60% CD-26 developed diluted with water for 1 minute to create an underetch profile to assist liftoff. 250 Å of chrome was then evaporated, followed by immersion in Remover PG for 1 hour at 70° C. for liftoff. 4) Optical lithography was performed with a double layer resist of LOR 3A/Shipley 1805 to define larger silicon features, such as the nanoplates and mesas to connect to metal interconnects. 250 Å of chrome was then evaporated, followed by immersion in Remover PG for 1 hour at 70° C. for liftoff to complete the full chrome hard mask used to define the active silicon. 5) The wafer was placed into a brief BOE dip to remove native oxide, then was placed into 60° C. TMAH for 1 min, 20 seconds to transfer the pattern from the chrome hard mask to the active silicon layer. 6) The chrome hard mask was then etched off using CR-14, a wet chrome etchant. Visual and AFM characterization was performed to determine the yield and thickness of the devices. 7) Wafers were then dry oxidized for 6 minutes at 1000° C. to form an implant slow down layer. 8) Optical lithography was then employed to form a photoresist mask for doping implantation of the source/drain regions of the devices. Wafers were doped with boron at 10 KeV at a dose of 1014 cm⁻² and a tilt of 7°. 9) At this point, the gate dielectric was formed. For SiO₂ devices, the wafers were dry oxidized for 3 minutes at 1000° C. to form a gate oxide of around 150 Å. This also served as a dopant activation step. For Al₂O₃ devices, after a brief BOE dip and dopant activation in nitrogen for 3 minutes at 1000° C., the wafers were placed into an atomic layer deposition (ALD) machine for 75 cycles of Al₂O₃ for a target thickness of 150 Å. 10) Wafers were then subjected to a Forming Gas Anneal to remove interfacial traps at 500° C. for 10 minutes in 5% H₂ in nitrogen. 11) Next, vias were formed in the silicon mesas with optical lithography and subsequent BOE etch to make solid, crack-free connection between metal interconnects and the silicon layers. AFM was performed over these regions to determine the silicon thickness (˜300 Å) and the gate dielectric thickness (˜150 Å). 12) 250 Å of titanium followed by 750 Å of platinum were then evaporated and lifted off over a double layer resist of LOR 3A/Shipley 1805 to pattern the metal traces. 13) A rapid thermal anneal was then performed at 550° C. for 2 minutes in a N₂ environment. This step ensures that the devices have good contact resistance, which translates into healthy source-drain currents dominated by the resistance of the channel instead of the resistance of the source-drain contacts. 14) After electrical testing to determine the yield of the devices at this step, 4500 Å of PECVD silicon nitride was deposited using a mixed frequency recipe for use as an insulation layer. 15) Optical lithography was then used to open holes directly over the pads on the external part of the chips. The silicon nitride was etched using a dry CF4 RIE etch (90 W, 36 mtorr, 15 minutes). A thick pad layer was then evaporated and lifted off for wire bonding (2000 Å/8000 Å of Ti/Au). 16) Next, etchback windows were opened directly over the active regions of the devices using optical lithography. 17) For Al₂O₃ devices, the etchback of the passivation layer could next be performed at a wafer level because of the high etch selectivity of silicon nitride over aluminum oxide (CF₄ RIE, 90 W, 36 mtorr, 15 minutes). SiO₂ devices were first diced into 4 mm×9.5 mm pieces, then were etched at a die by die basis (CF4 RIE, 90 W, 36 mtorr, time varied) with constant visual inspection to ensure that the etch stopped on the top oxide gate dielectric.

FIG. 6a shows views of the four different patterns of nanowires that were patterned on the devices: Five 50 nm wide nanowires separated by 200 nm (upper left). Five 50 nm wide nanowires, separated by 200 nm, 400 nm, 800 nm, and 2 μm (upper right). Four devices, with widths of 50 nm, 200 nm, 400 nm, and 1 μm, separated by 200 nm, 400 nm, and 1 μm (lower left). Nanoplate devices with widths of 2 μm, separated by microns (lower right).

Taking cross sections of the devices at various steps during the fabrication was part of finishing with a structure with high robustness and reliability. An example of a previous fabrication run is shown in FIG. 6b. On the left, it can be seen that the interface between the silicon nitride passivation layer and the gate dielectric has formed highly undesirable cracks and holes that can lead to device degradation. The choice of etch back conditions can also make a huge difference. For example, on the right of FIG. 6b, a wet etch back with BOE was used to expose the devices to the fluid. Here, the passivation layer has been completely removed from the edges of the device, leaving the device completely exposed to fluid (which resulted in devices that were not stable in fluid and were highly prone to leakage currents).

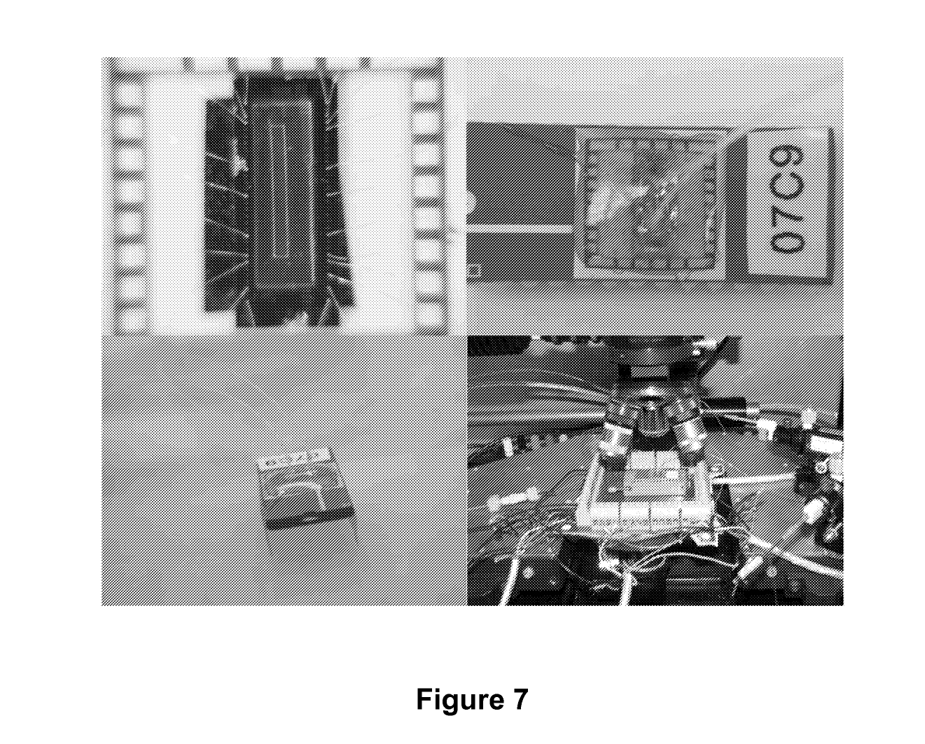

Measurement Setup. 4 mm×9.5 mm chips were placed into ceramic packages (Global Chip Materials 28 pin lead sized brazed package) as shown in FIG. 7. Microfluidic channels were aligned to the chip using a mask aligner, and individual devices were contacted using wire bonding to the package. Teflon tubing was inserted into the ends of the channel, and the entire setup was covered with slow drying epoxy to insulate the devices and to mitigate fluid leakage issues. The entire ceramic package was then placed into a custom designed PC board connected to a computer that could individually address any of the devices that were wire bonded. Fluid was exchanged using the tubing and syringe pumps with syringes containing the various different solutions. All pH solutions were measured at the conclusion of the experiment to ensure that the pH had not changed significantly during the course of the experiment. Electrical current measurements and applied biases were controlled by a semiconductor parameter analyzer (Keithley 4200).

CARRIER CONCENTRATION SIMULATIONS. To obtain the carrier concentration profile inside the silicon channel as a function of the back gate bias, Medici was used with the two-dimensional planar structure. The electrolyte was modeled between fluid gate and top oxide as an insulator with thickness of 5 nm and dielectric constant of water (78.5 in the simulation). Since 5 mM electrolyte was used in the experiment, the corresponding Debye length (−5 nm) can be reasonably used for the thickness of electrolyte layer. The fluid gate bias is also assumed negative (−1 V in the simulation), and the OH surface group is a negative (−10¹³ cm⁻² in the simulation) fixed charge on the top oxide surface since the usual range of electrolyte pH is higher than the point-of-zero charge (pH_{pzc}) of SiO₂ surface, which is equal to 1-3. To see the effect of the back gate bias, two different values of Vbg were used for the simulation: −7 and +3 V.

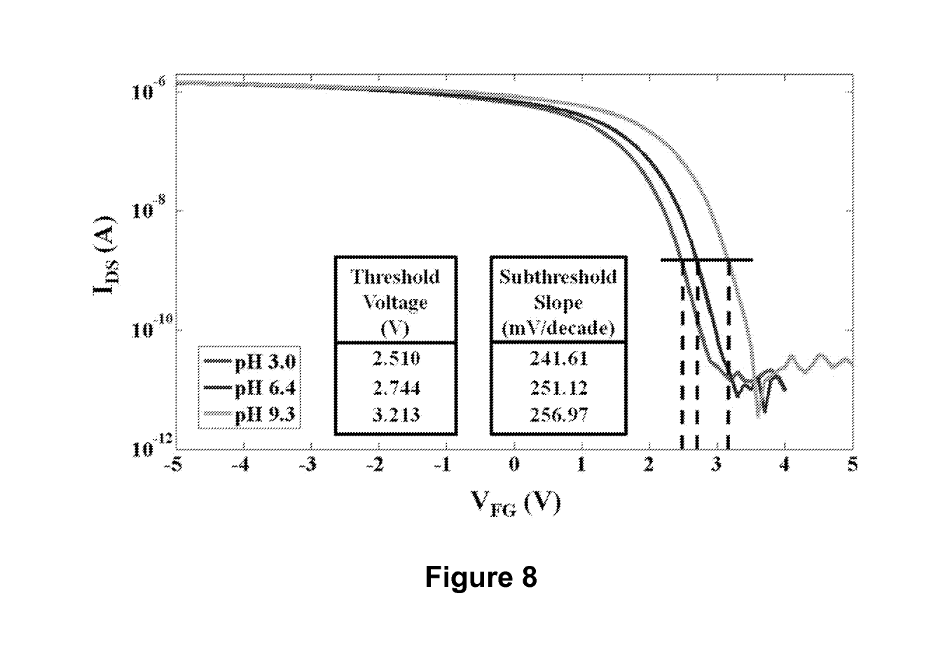

THRESHOLD VOLTAGE CALCULATION. Threshold voltage for each of the transfer curves was extracted using a simple constant current method that is demonstrated in FIG. 8 (shown for a SiO₂ 50 nm wide nanowire device). Because the subthreshold slope was observed to be relatively constant for varying pH (the curves are parallel to one another at different pH values), simply extracting the voltage at which the source-drain current dipped below a certain value could be used as a first order measurement of the threshold voltage shifts induced by changes in pH.

FIGURE CAPTIONS. FIG. 1: Device structure. (a) Fabrication process for the Nano-FETs. 1—Patterning of Chrome hard mask via electron beam and optical lithography. 2—Wet Etch of the active silicon area with TMAH. 3—Deposition (Al₂O₃) or growth (SiO₂) of the gate dielectric. 4—Deposition and patterning of platinum as the metal contact; contact is made with via holes into the silicon. 5—Deposition of Si₃N₄ passivation layer, followed by etchback to expose the devices and the fluid gate. (b) Scanning electron micrographs of NW-FETs, demonstrating how mesas are used to make contact to the wires and to the metal traces. (c) SEM of a cross section of three NW-FETs (through the line in b). A protective platinum layer was placed over the cross section to prevent damage to the surface while taking the cross-section. (d) SEM of a cross section of a single nanoplate FET.

FIG. 2: Device operation. (a) Schematic demonstrating the measurement scheme for the nanoFETs. DC voltages are applied to the back substrate as a backgate (VBG), to the on chip platinum reference electrode as a fluid gate (VFG), and to the drain (VDS=1 V for all experiments). Current is recorded from source to drain for the device. (b) Open circuit potential between the employed on-chip platinum electrode and a reference Ag/AgCl electrode as a function of pH, in Robinson buffer. A slope of around −41 mV/pH is observed. (c) Typical dry device operation for Al₂O₃ nanoFETs: both a 50 nm wide silicon nanowire and a 2 μm wide silicon nanoplate. Source-drain current (log scale) as a function of the applied backgate voltage. Included are the extracted threshold voltages and subthreshold slopes for the devices. (d) Measured source-drain current for an Al₂O₃ nanoFET in pH 7.4 0.01× PBS buffer solution where the applied fluid gate is swept for many different applied backgate biases. (e) Front threshold voltage versus time for 5 Al₂O₃ nanoFET devices demonstrating device stability. Very little shift in threshold voltage over time is observed for up to 8 hours in Robinson buffer (pH 7.5). This allows for determination of the minimum detectable shift in threshold voltage (˜50 mV). (f) Measured back to front leakage current as a function of time in 0.01× PBS for a 50 nm wide Al₂O₃ nanowire device. Devices are observed to maintain low leakage currents many months after initial measurement in fluid.

FIG. 3: The influence of the applied backgate bias on pH sensing. (a) Schematic demonstrating the concept of using a backgate voltage to modulate the effective electrical thickness of the channel. On the left, when the back surface of the silicon is assumed to be in accumulation, a large percentage of the cross sectional area of the conductive channel (anything below the Debye length from the front) will not sense changes in charge at the dielectric-fluid interface. On the right, when the back surface is placed in depletion, the effective conductive thickness of the channel has been reduced so that the majority of the channel can detect charge. The fluid gate is assumed to be biased in both cases to place the front surface in accumulation. (b) Simulated carrier densities in the channel of nanoFET devices for the case of back accumulated (VBA=−7 V) and back depleted (VBD=−4 V). The front gate was accumulated, at VFG=−1 V, and the concentration of charged sites on the surface was taken to be Ns=1013 cm−2. (c) Experimental data showing the percentage change in current from the current at pH 3.0 for a 50 nm wide SiO₂ nanowire device at two different backgate voltages in accumulation and depletion (VBA=−7 V and VBD=−4 V). A higher sensitivity is noted in the case of the back depletion.

FIG. 4: Experimental comparison of pH-induced threshold changes using three Al₂O₃ NWFET devices and three SiO₂ devices. The Al₂O₃ devices demonstrate a higher sensitivity to pH, which is expected based on the difference in buffer capacities of the surfaces.

FIG. 5: Comparison of NWFET devices and nanoplate FET devices. (a) Schematic illustrating two separate cases: when the silicon Debye length is much less than the silicon thickness (top) and when the Debye length is much greater (bottom). A large difference in the % of the channel that can sense charge at the dielectric/fluid interface is noted for nanowire vs. nanoplate in the top case, whereas no difference is seen in the bottom case. (b) Shift in threshold voltage from pH 3.0 for six SiO₂ devices: three nanowire and three nanoplate devices. Observed response lies within the error bars, showing that the NWs and NPs exhibit very similar responses to pH. (c) Shift in threshold voltage from pH 3.0 for six Al₂O₃ devices: three nanowire and three nanoplate devices. Once again it is difficult to distinguish the difference between the two responses.

FIG. 6: Device fabrication issues. (a) Four different patterns of the FET devices. (b) SEM cross sections of a previous fabrication run, showing serious issues with cracks (on the left) which result in highly undesirable etchback where the silicon devices are left unprotected from fluid, which leads to leakage currents. On the right, a cross section of a device that was exposed using a wet BOE etch back is shown. The device is left unprotected from fluid, which lead to undesirable leakage currents and poor device reliability in fluid.

FIG. 7: Measurement Setup. Upper left—Chip placed in a ceramic package, with a microfluidic channel and individual devices wire bonded. Upper right and lower left—ceramic package covered in epoxy for insulation with microfluidic tubing. Lower right—ceramic package placed into a PC board with connections to allow for the addressing of any desired device.

FIG. 8: Extraction of Threshold Voltage Shifts. The transfer curves for a 50 nm wide nanowire device immersed in pH solutions of 3 different pH values (3.0, 6.4, and 9.3) are shown, included with the threshold voltage and subthreshold slope of each curve. Since the curves are relatively parallel to one another, the threshold voltage shifts can be extracted by simply calculating the voltage at which each curve dips below a current threshold.

### EXAMPLE 2

### Fabrication Flow Diagrams for Making a Chemical Sensor Embodiment

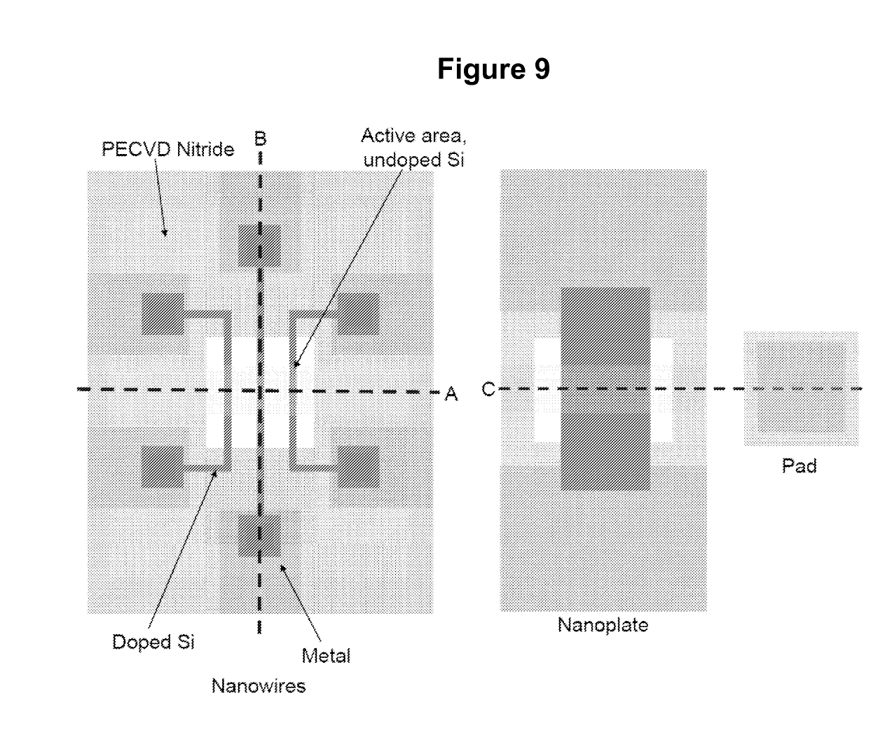

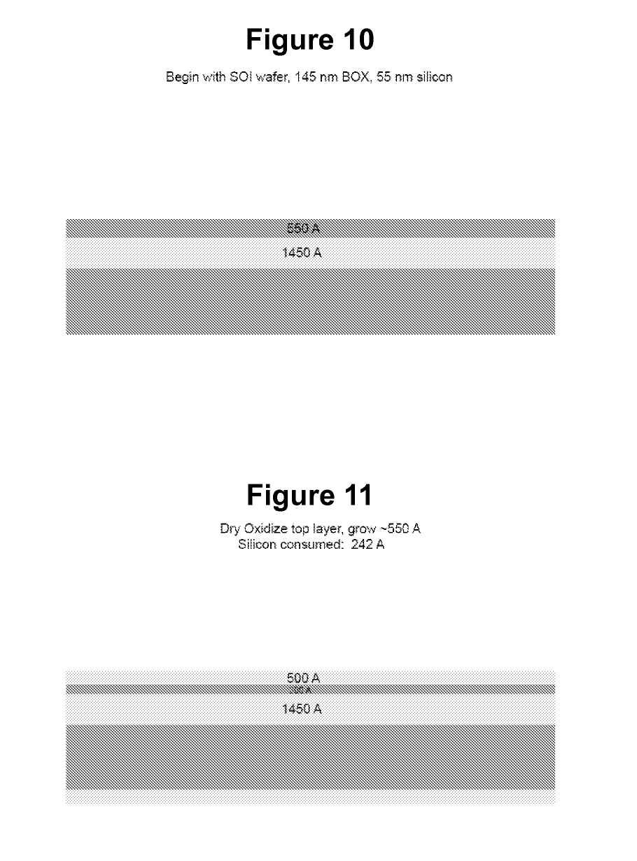

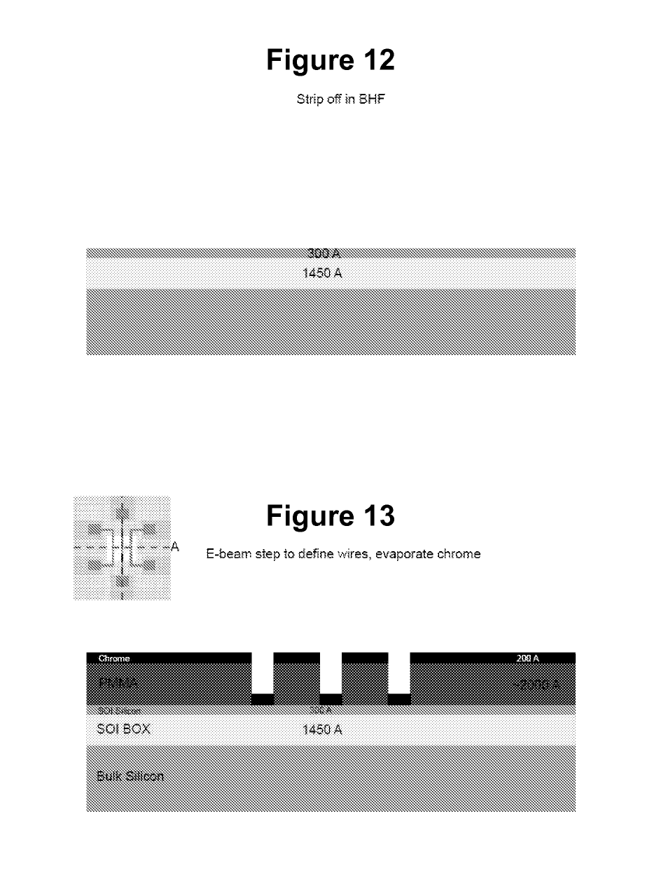

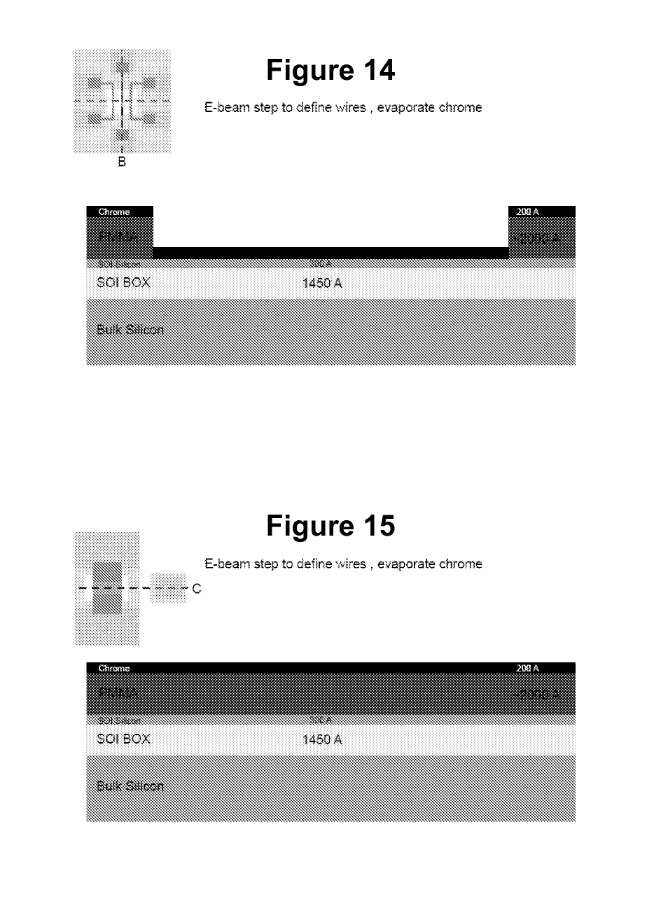

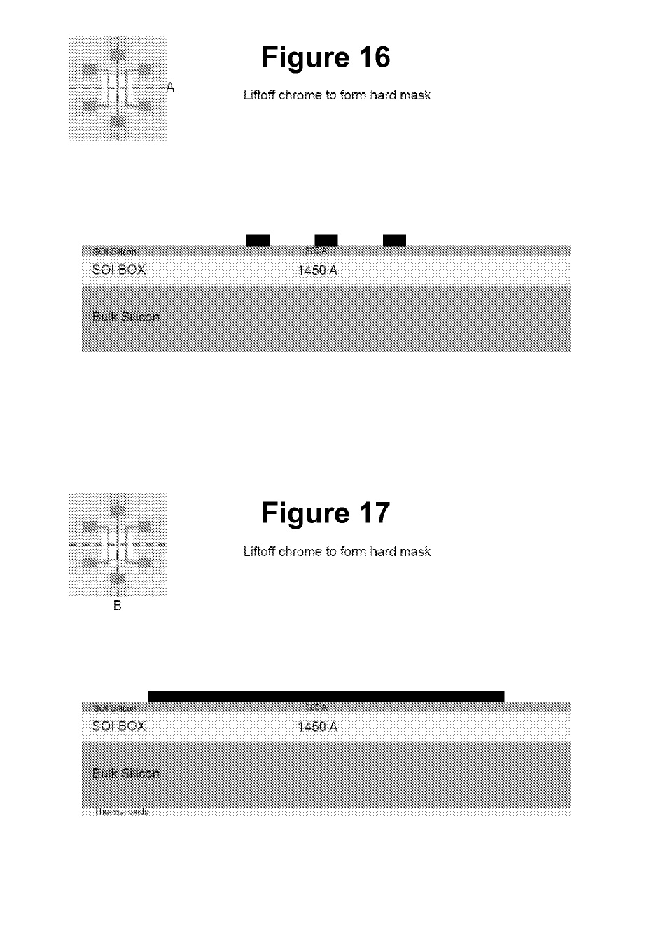

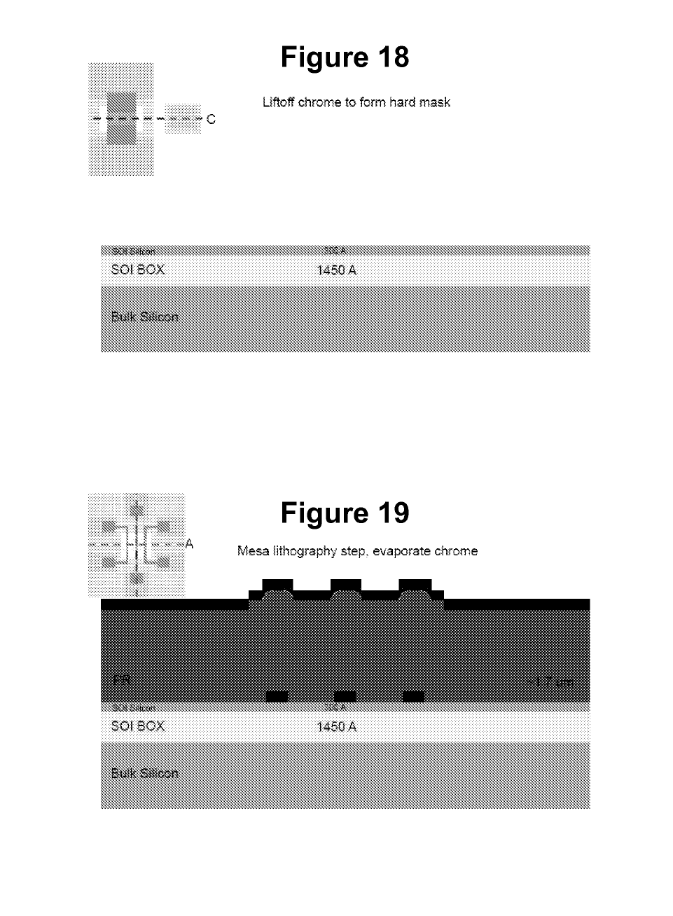

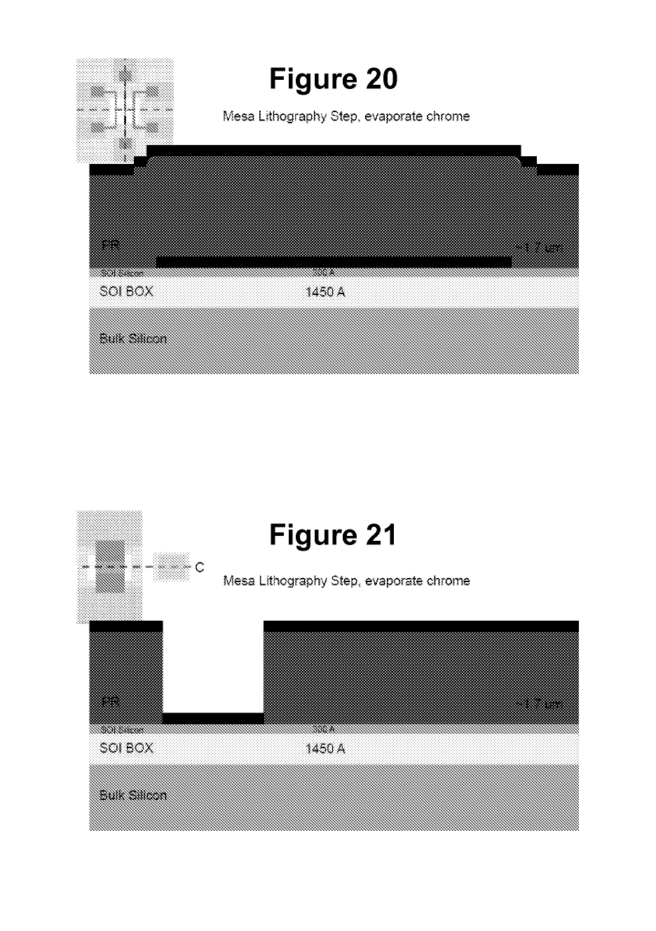

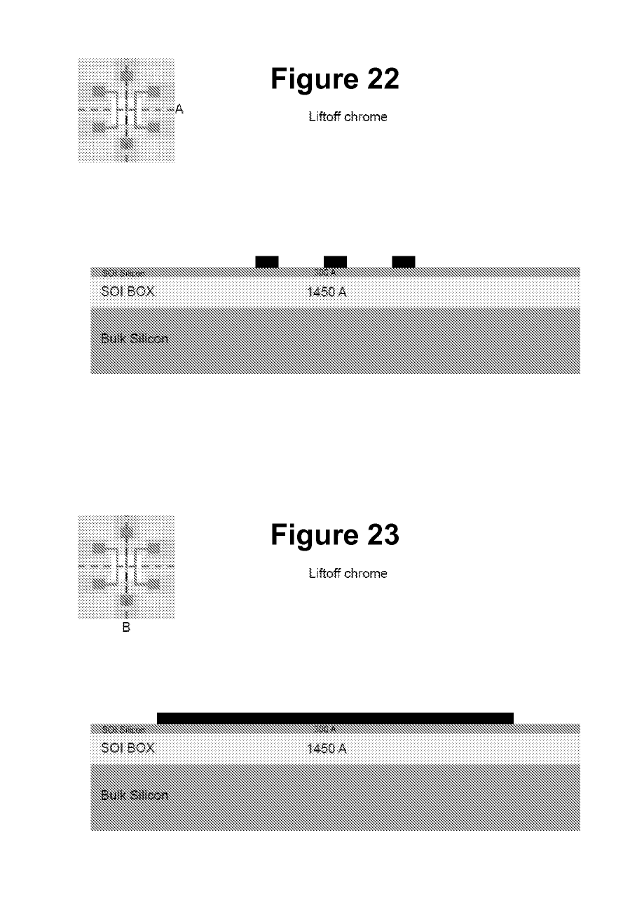

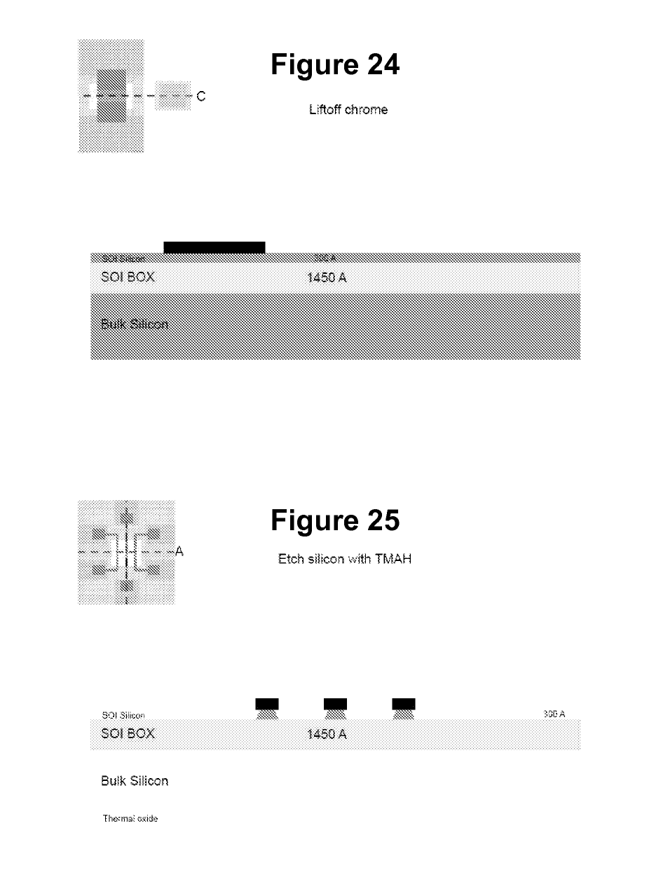

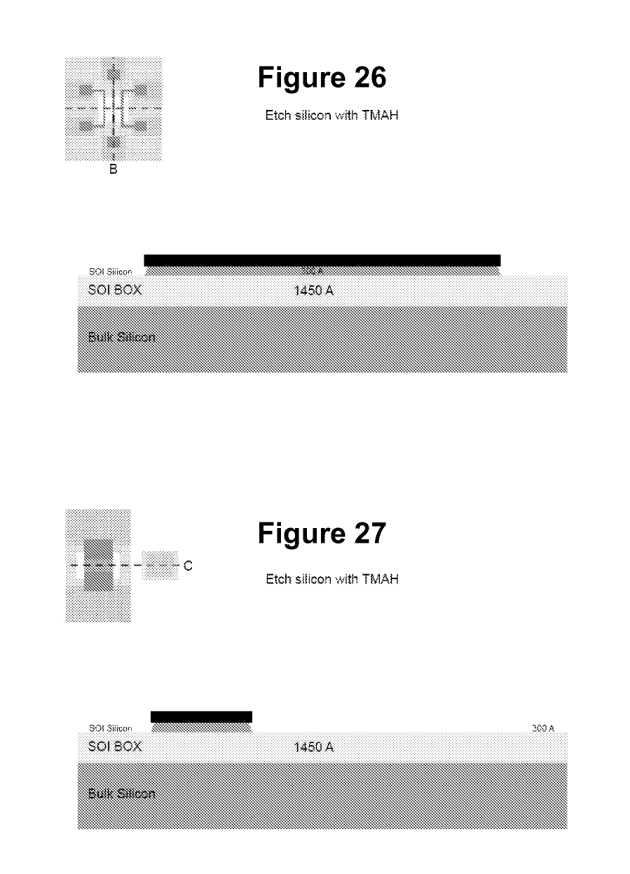

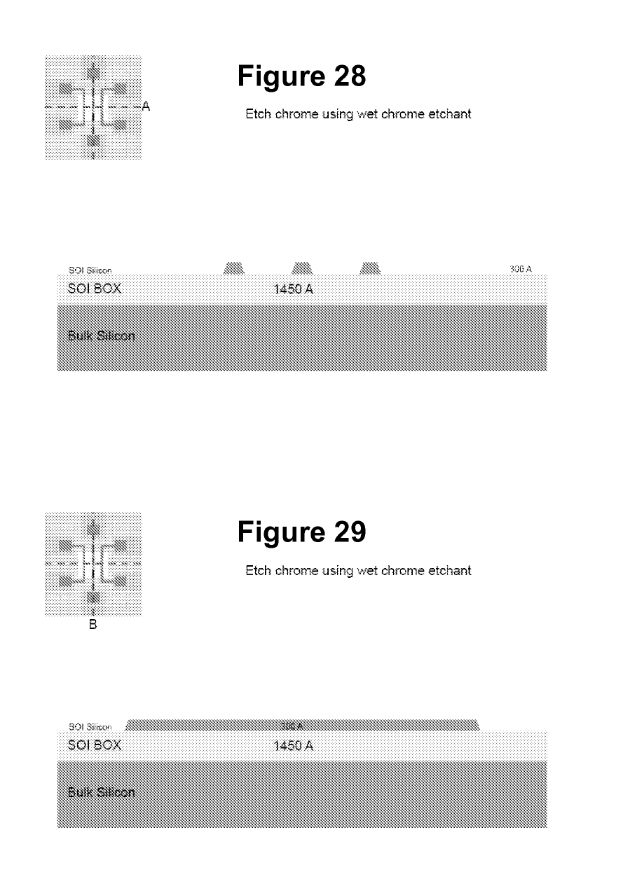

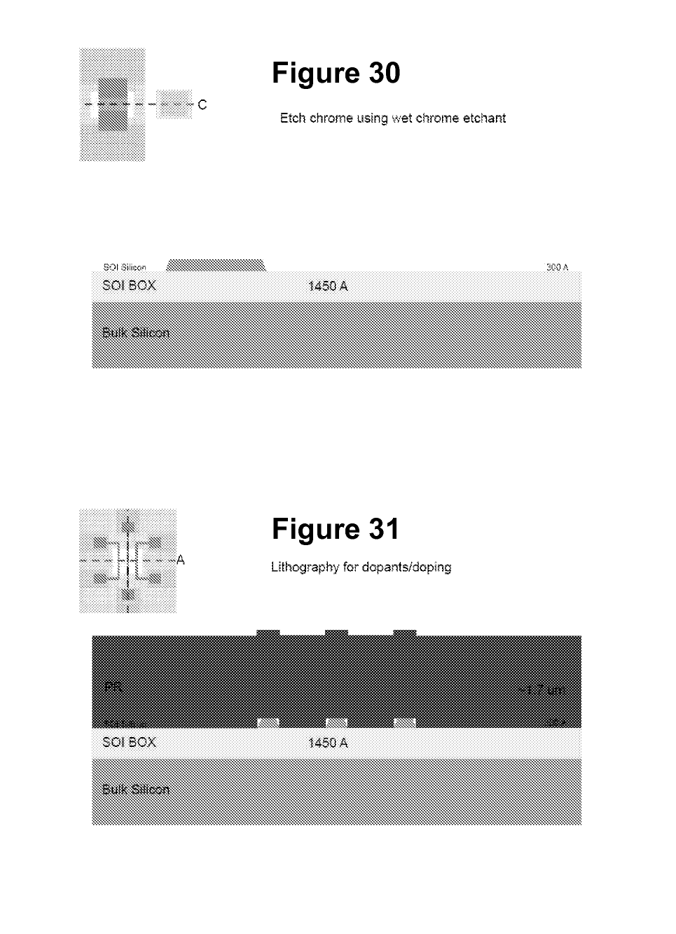

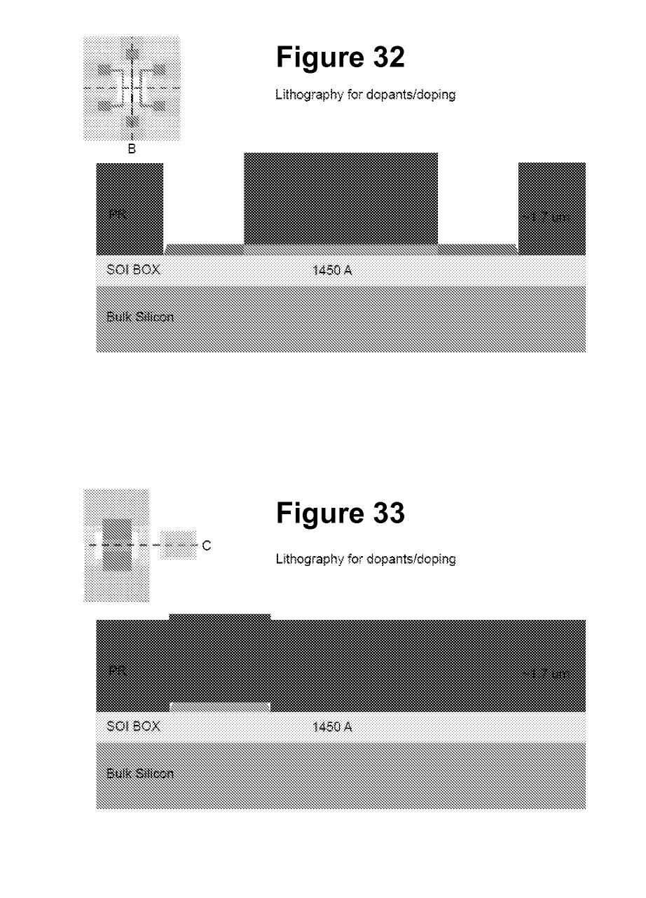

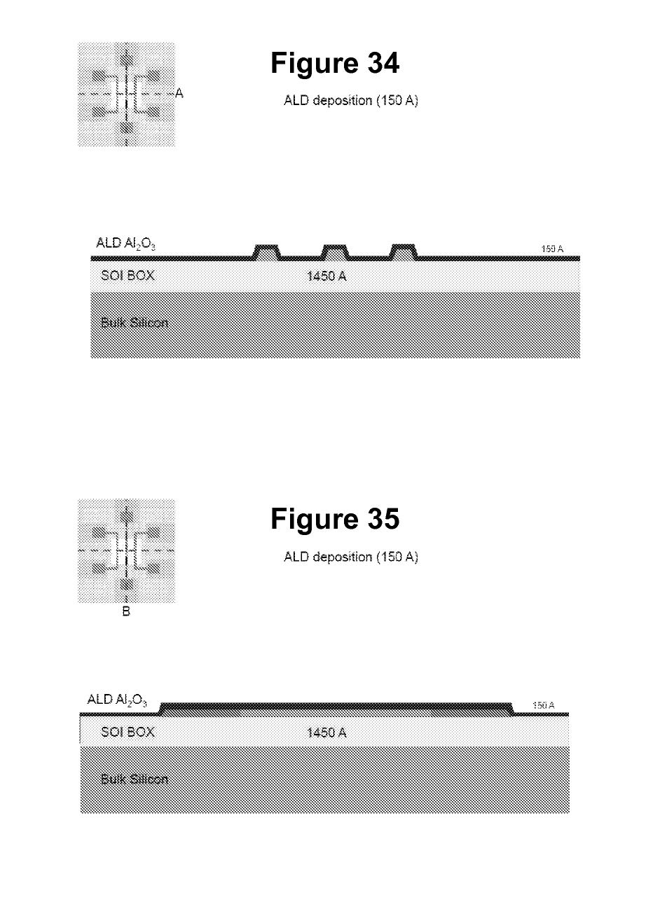

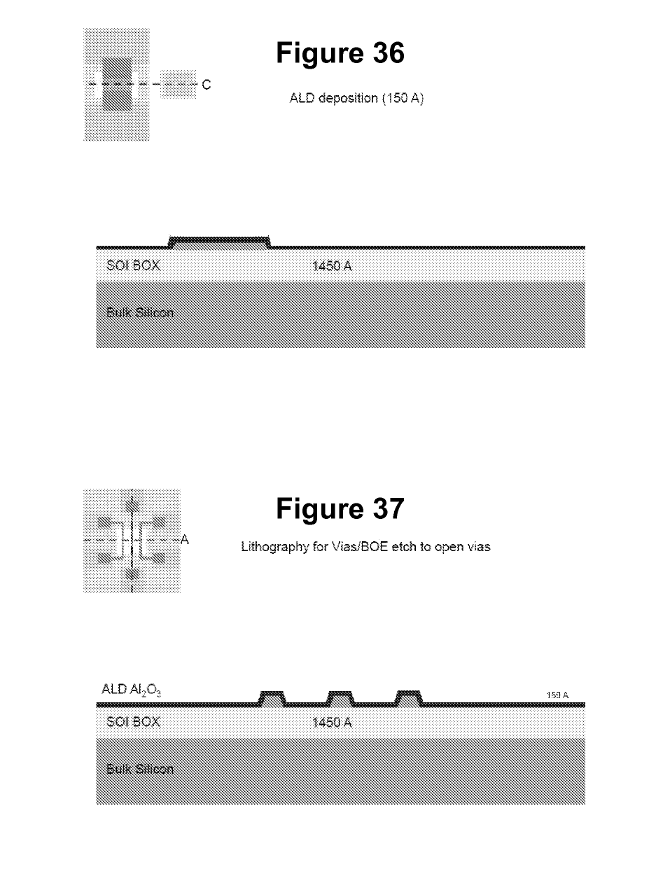

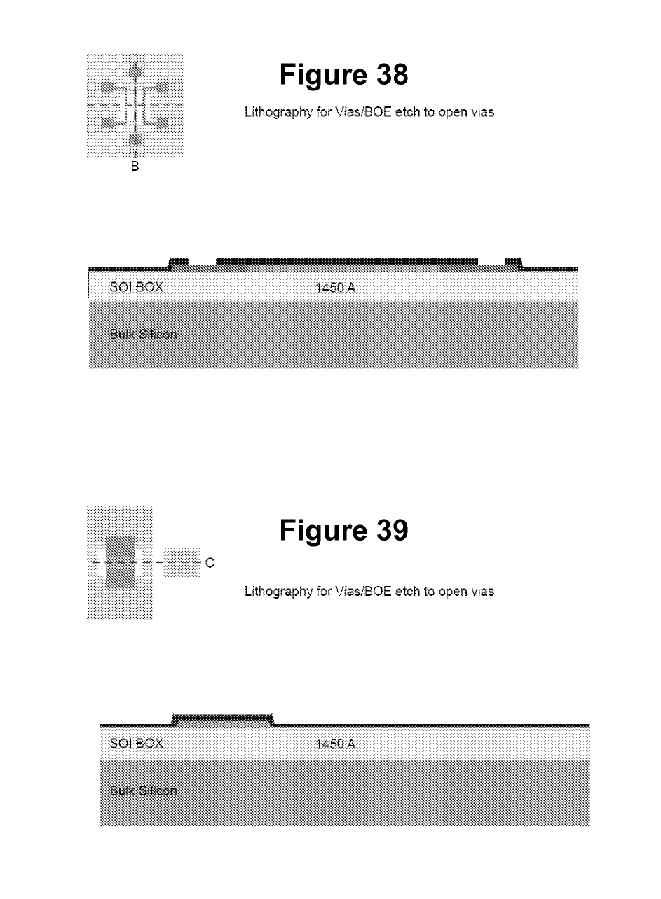

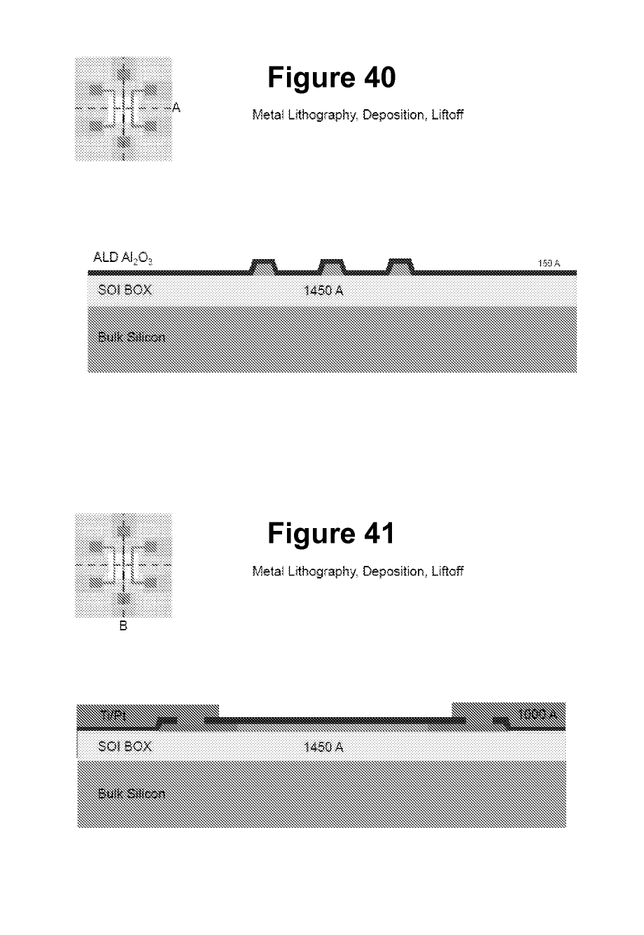

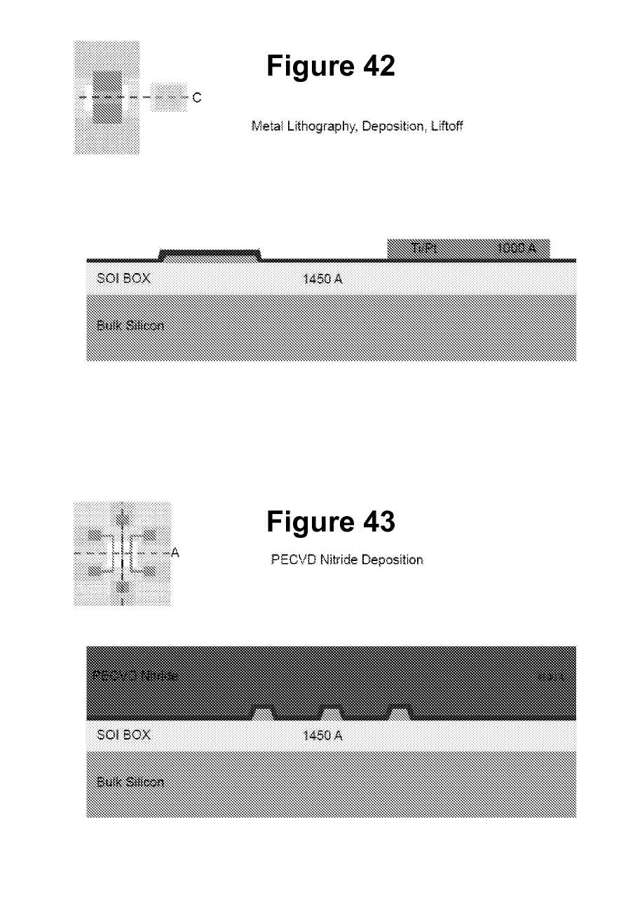

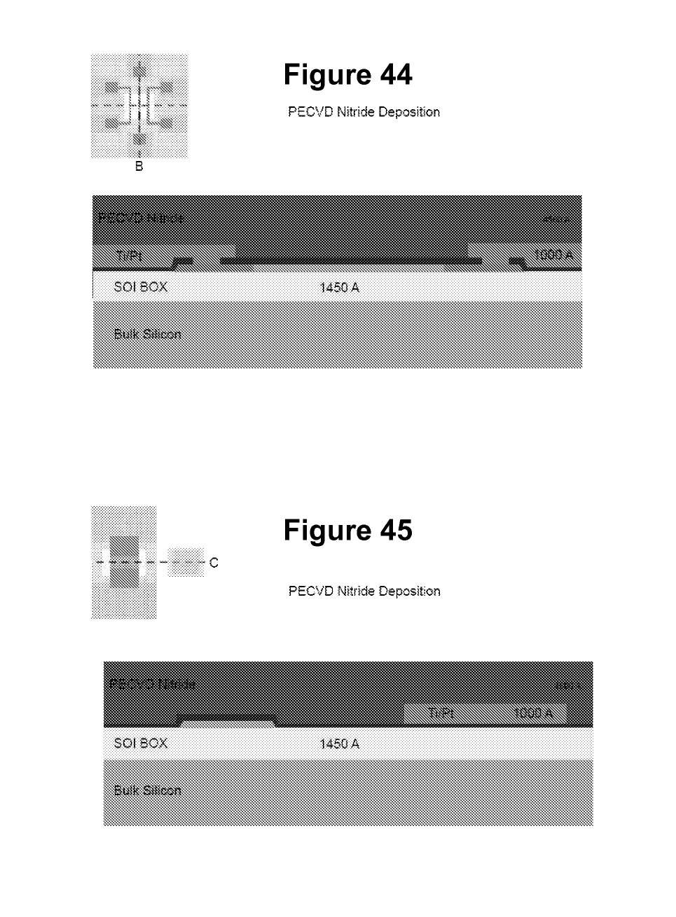

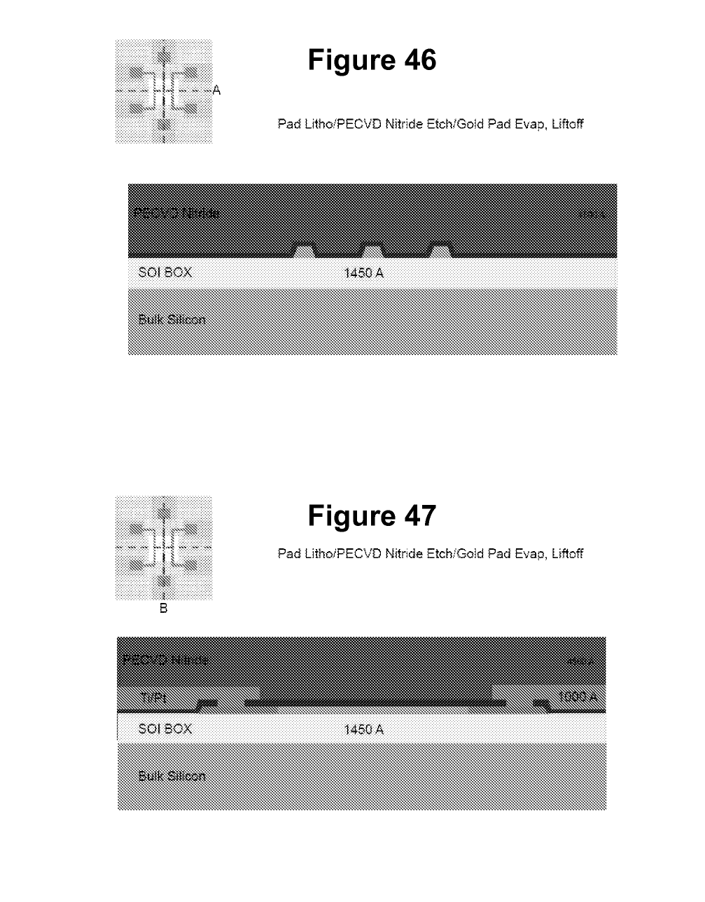

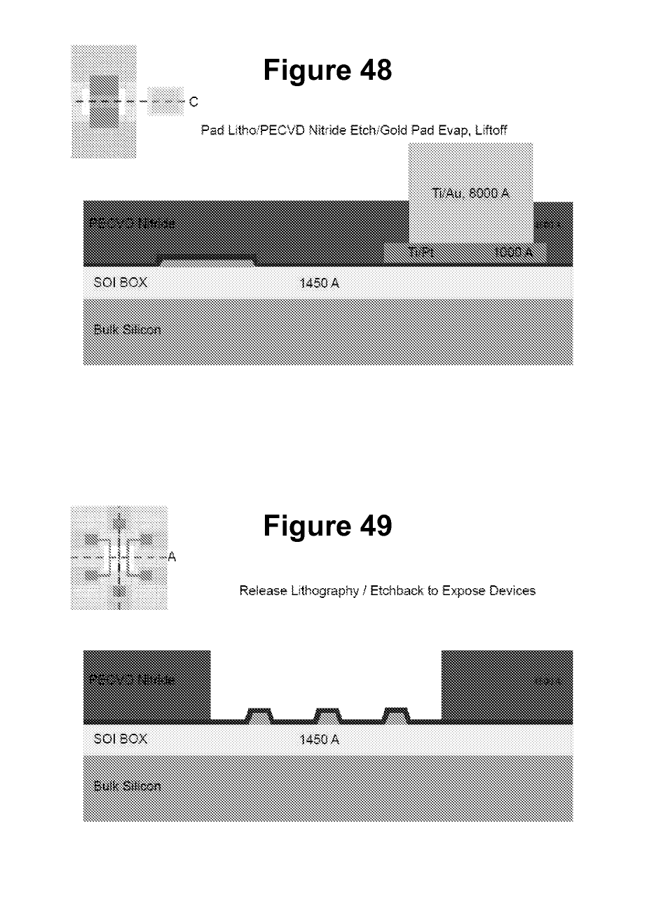

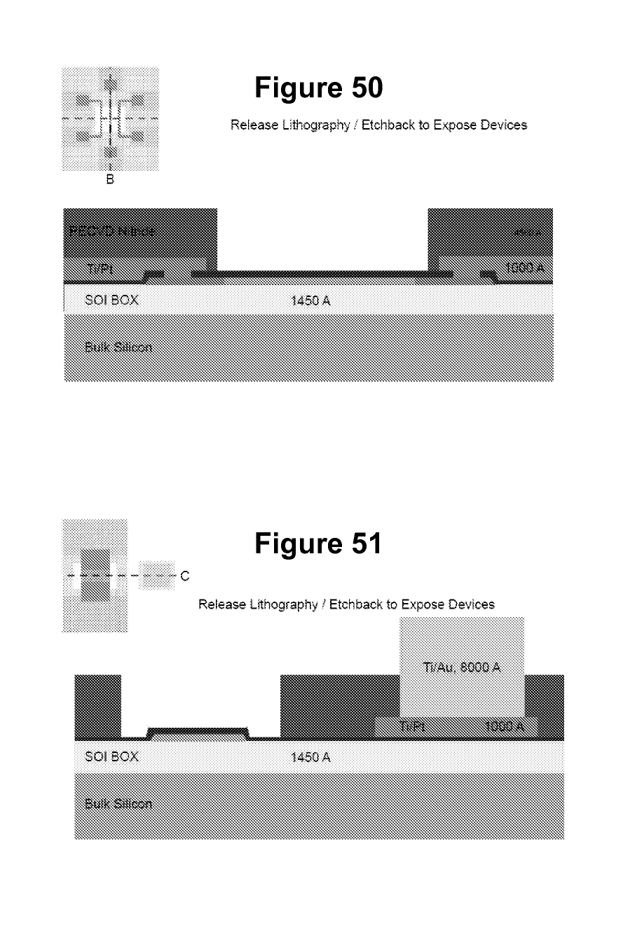

FIG. 9 provides an overview of nanoplate and nanowire chemical sensor devices having a fluid gate electrode. FIGS. 10-51 provide an overview of fabrication steps for the sensor devices shown in FIG. 9. Insets of the figures show a reduced size version of components of FIG. 9 identifying the cross sectional view shown (i.e., along axis A, axis B or axis C). Fabrication of this embodiment begins with a SOI wafer having a 145 nm buried oxide layer with a 55 nm silicon top layer (FIG. 10). The top silicon layer is dry oxidized to grow an oxide layer approximately 500-550 Å and reduce the silicon layer approximately 250 Å (FIG. 11). The top oxide layer is stripped off in BHF (FIG. 12). A PMMA layer of 20 nm is provided over the devices and an e-beam is used to define the nanowire devices followed by a chrome evaporation step (FIGS. 13, 14 and 15). Liftoff of the PMMA layer leaves a chrome hard mask over the top silicon layer (FIGS. 16, 17, and 18). A photoresist layer is patterned over the first hard mask to define the nanoplate device followed by a chrome evaporation step (FIGS. 19, 20 and 21). Liftoff of the photoresist layer leaves chrome hard masks over the top silicon layer (FIGS. 22, 23 and 24). The top silicon layer is then etched with TMAH (FIGS. 25, 26 and 27). The chrome masks are then etched using a wet chrome etchant (FIGS. 28, 29 and 30). Another layer of photoresist is patterned over the silicon top layer as a mask for implantation of dopants into the top silicon layer (FIGS. 31, 32 and 33). The photoresist layer is removed and a high-k dielectric layer (e.g., Al₂O₃) is deposited over the devices using Atomic Layer Deposition (FIGS. 34, 35 and 36). Vias are patterned into the high-k dielectric layer to form electrode contact regions to the doped silicon regions (FIGS. 37, 38 and 39). Metal regions are then patterned to form the electrode contacts (FIGS. 40, 41 and 42). A dielectric overlayer (e.g., Si₃N₄) is deposited over the devices (FIGS. 43, 44 and 45). The dielectric layer is etched and the fluid gate electrode is established (FIGS. 46, 47 and 48). Finally, the dielectric layer is etched to expose the nanowire and nanoplate devices (FIGS. 49, 50 and 51).

### REFERENCES

Bergveld, P., IEEE Transactions on Biomedical Engineering 1970, 17, (1), 70-71.

Bergveld, P., IEEE Transactions on Biomedical Engineering 1972, 19, (5), 342-351.

Vanderschoot, B. H.; Bergveld, P., Biosensors 1987, 3, (3), 161-186.

Vanderschoot, B. H.; Bergveld, P., Analytica Chimica Acta 1987, 199, 157-160.

Bergveld, P., Biosensors & Bioelectronics 1991, 6, (1), 55-72.

Kruise, J.; Rispens, J. G.; Bergveld, P.; Kremer, F. J. B.; Starmans, D.; Haak, J. R.; Feijen, J.; Reinhoudt, D. N., Sensors and Actuators B-Chemical 1992, 6, (1-3), 101-105.

Vankerkhof, J. C.; Bergveld, P.; Schasfoort, R. B. M., Biosensors & Bioelectronics 1993, 8, (9-10), 463-472.

Olthuis, W.; Luo, J.; Bergveld, P., Biosensors & Bioelectronics 1994, 9, (9-10), 743-751.

Schasfoort, R. B. M.; Bergveld, P.; Bomer, J.; Kooyman, R. P. H.; Greve, J., Sensors and Actuators 1989, 17, (3-4), 531-535.

Baumann, W. H.; Lehmann, M.; Schwinde, A.; Ehret, R.; Brischwein, M.; Wolf, B., Sensors and Actuators B-Chemical 1999, 55, (1), 77-89.

Lehmann, M.; Baumann, W.; Brischwein, M.; Ehret, R.; Kraus, M.; Schwinde, A.; Bitzenhofer, M.; Freund, I.; Wolf, B., Biosensors & Bioelectronics 2000, 15, (3-4), 117-124.

Vanhal, R. E. G.; Eijkel, J. C. T.; Bergveld, P., Sensors and Actuators B-Chemical 1995, 24, (1-3), 201-205.

vanHal, R. E. G.; Eijkel, J. C. T.; Bergveld, P., Advances in Colloid and Interface Science 1996, 69, 31-62.

Bergveld, P., Sensors and Actuators B-Chemical 2003, 88, (1), 1-20.

Nair, P. R.; Alam, M. A., Applied Physics Letters 2006, 88, (23), 233120.

Squires, T. M.; Messinger, R. J.; Manalis, S. R., Nature Biotechnology 2008, 26, (4), 417-426.

Cui, Y.; Wei, Q. Q.; Park, H. K.; Lieber, C. M., Science 2001, 293, (5533), 1289-1292.

Hahm, J.; Lieber, C. M., Nano Letters 2004, 4, (1), 51-54.

Fang, Y.; Patolsky, F.; Lieber, C. M., Biophysical Journal 2007, 551a.

Li, Z.; Chen, Y.; Li, X.; Kamins, T. I.; Nauka, K.; Williams, R. S., Nano Letters 2004, 4, (2), 245-247.

Bunimovich, Y. L.; Shin, Y. S.; Yeo, W. S.; Amori, M.; Kwong, G.; Heath, J. R., Journal of the American Chemical Society 2006, 128, (50), 16323-16331.

Fritz, J.; Cooper, E. B.; Gaudet, S.; Sorger, P. K.; Manalis, S. R., Proceedings of the National Academy of Sciences of the United States of America 2002, 99, (22), 14142-14146.

Zhang, G. J.; Zhang, G.; Chua, J. H.; Chee, R. E.; Wong, E. H.; Agarwal, A.; Buddharaju, K. D.; Singh, N.; Gao, Z. Q.; Balasubramanian, N., Nano Letters 2008, 8, (4), 1066-1070.

Zhang, G. J.; Chua, J. H.; Chee, R. E.; Agarwal, A.; Wong, S. M., Biosensors & Bioelectronics 2009, 24, (8), 2504-2508.

Zhang, G. J.; Chua, J. H.; Chee, R. E.; Agarwal, A.; Wong, S. M.; Buddharaju, K. D.; Balasubramanian, N., Biosensors & Bioelectronics 2008, 23, (11), 1701-1707.

Zheng, G. F.; Patolsky, F.; Cui, Y.; Wang, W. U.; Lieber, C. M., Nature Biotechnology 2005, 23, (10), 1294-1301.

Patolsky, F.; Zheng, G. F.; Lieber, C. M., Nature Protocols 2006, 1, (4), 1711-1724.

Chua, J. H.; Chee, R. E.; Agarwal, A.; Wong, S. M.; Zhang, G. J., Analytical Chemistry 2009, 81, (15), 6266-6271.

Stern, E.; Klemic, J. F.; Routenberg, D. A.; Wyrembak, P. N.; Turner-Evans, D. B.; Hamilton, A. D.; LaVan, D. A.; Fahmy, T. M.; Reed, M. A., Nature 2007, 445, (7127), 519-522.

Stern, E.; Vacic, A.; Rajan, N. K.; Criscione, J. M.; Park, J.; Ilic, B. R.; Mooney, D. J.; Reed, M. A.; Fahmy, T. M., Nature Nanotechnology 2010, 5, (2), 138-142.

Patolsky, F.; Zheng, G. F.; Hayden, 0.; Lakadamyali, M.; Zhuang, X. W.; Lieber, C. M., Proceedings of the National Academy of Sciences of the United States of America 2004, 101, (39), 14017-14022.

Patolsky, F.; Timko, B. P.; Yu, G. H.; Fang, Y.; Greytak, A. B.; Zheng, G. F.; Lieber, C. M., Science 2006, 313, (5790), 1100-1104.

Cohen-Karni, T.; Timko, B. P.; Weiss, L. E.; Lieber, C. M., Proceedings of the National Academy of Sciences of the United States of America 2009, 106, (18), 7309-7313.

Stern, E.; Steenblock, E. R.; Reed, M. A.; Fahmy, T. M., Nano Letters 2008, 8, (10), 3310-3314.

Chen, S. Y.; Bomer, J. G.; van der Wiel, W. G.; Carlen, E. T.; van den Berg, A., ACS Nano 2009, 3, (11), 3485-3492.

Tong, H. D.; Chen, S.; van der Wiel, W. G.; Carlen, E. T.; van den Berg, A., Nano Letters 2009, 9, (3), 1015-1022.

Juhasz, R.; Elfstrom, N.; Linnros, J., Nano Letters 2005, 5, (2), 275-280.

Elfstrom, N.; Juhasz, R.; Sychugov, I.; Engfeldt, T.; Karlstrom, A. E.; Linnros, J., Nano Letters 2007, 7, (9), 2608-2612.

Elfstrom, N.; Karlstrom, A. E.; Linnrost, J., Nano Letters 2008, 8, (3), 945-949.

Elfstrom, N.; Linnros, J., Nanotechnology 2008, 19, (23).

Elibol, O. H.; Reddy, B.; Bashir, R., Applied Physics Letters 2008, 92, (19).

Stern, E.; Wagner, R.; Sigworth, F. J.; Breaker, R.; Fahmy, T. M.; Reed, M. A., Nano Letters 2007, 7, (11), 3405-3409.

Gao, X. P. A.; Zheng, G. F.; Lieber, C. M., Nano Letters 2010, 10, (2), 547-552.

Patolsky, F.; Zheng, G. F.; Lieber, C. M., Analytical Chemistry 2006, 78, (13), 4260-4269.

Venkatesan, B. M.; Dorvel, B.; Yemenicioglu, S.; Watkins, N.; Petrov, I.; Bashir, R., Advanced Materials 2009, 21, (27), 2771-2776.

Dankerl, M.; Reitinger, A.; Stutzmann, M.; Garrido, J. A., Physica Status Solidi-Rapid Research Letters 2008, 2, (1), 31-33.

Iniguez, B.; Gentinne, B.; Dessard, V.; Flandre, D., IEEE Transactions on Electron Devices 1999, 46, (12), 2295-2303.

Jang, S. L.; Liu, S. S., Solid-State Electronics 1999, 43, (1), 87-96.

Joachim, H. O.; Yamaguchi, Y.; Inoue, Y.; Nishimura, T.; Tsubouchi, N., Japanese Journal of Applied Physics 1994, 33, (1B), 558-562.

Robertson, J., European Physical Journal-Applied Physics 2004, 28, (3), 265-291.

Nair, P. R.; Alam, M. A., Nano Letters 2008, 8, (5), 1281-1285.

### STATEMENTS REGARDING INCORPORATION BY REFERENCE AND

VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing or publication date, and it is intended that this information can be employed herein, if needed, to exclude (for example, to disclaim) specific embodiments that are in the prior art.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/or” means that one, all, or any combination of items in a list separated by “and/or” are included in the list; for example “1, 2 and/or 3” is equivalent to “‘1’ or ‘2’ or ‘3’ or ‘1 and 2’ or ‘1 and 3’ or ‘2 and 3’ or ‘1, 2 and 3’”.

Every formulation or combination of components described or exemplified can be used to practice the invention, unless otherwise stated. Specific names of materials are intended to be exemplary, as it is known that one of ordinary skill in the art can name the same material differently. One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of excludes any element, step, or ingredient not specified in the claim element. As used herein, “consisting essentially of does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A semiconductor field effect sensor comprising:
a source region,
a drain region,
a channel region positioned between the source and drain regions,
a buried back gate positioned at least partly below the channel region;
a sensing region positioned over the channel region, the sensing region comprising a high-k dielectric layer;
a fluid positioned in contact with the sensing region; and
a fluid gate electrode positioned in contact with the fluid;
wherein the sensor is electrically stable when the fluid is in contact with the sensing region.

2. The sensor of claim 1, wherein the sensor is electrically stable when the fluid is in contact with the sensing region for a period greater than 1 minute, a period greater than 30 minutes, a period greater than 1 day, a period greater than 1 week, or a period greater than 1 month or a period greater than 10 months.

3. The sensor of claim 1 or claim 2, wherein a leakage current between the source region and the back gate, between the drain region and the back gate or between the channel region and the back gate is insufficient to permanently damage the sensor.

4. The sensor of claim 1, wherein a leakage current between the source region and the fluid, between the drain region and the fluid or between the channel region and the fluid is insufficient to permanently damage the sensor.

5. The sensor of claim 3, wherein the leakage current is smaller than 1 μA, smaller than 0.1 μA, or selected over the range of 1 μA to 0.01 μA.

6. The sensor of claim 1, wherein the high-k dielectric layer has a thickness selected over the range of 0.1 nm-10 μm.

7. The sensor of claim 1, wherein the high-k dielectric layer is deposited over the channel region using atomic layer deposition.

8. The sensor of claim 1, wherein the high-k dielectric is selected from the group consisting of Al₂O₃, HfO₂, ZrO₂, HfSiO₄, ZrSiO₄ and any combination of these.

9. The sensor of any of claims 1 8 claim 1, wherein the sensing region further comprises a metal layer positioned over at least a portion of the high-k dielectric layer.

10. The sensor of claim 9, wherein the metal layer comprises a metal selected from the group consisting of Al, Pt, and Au.

11. The sensor of claim 9, wherein the metal layer has a thickness selected over the range of 0.1 nm-100 μm.

12. The sensor of claim 1, wherein the source and drain regions independently comprise doped semiconductors.

13. The sensor of claim 1, further comprising a semiconductor oxide layer positioned between the channel region and the high-k dielectric layer.

14. The sensor of claim 1, wherein the back gate is biased relative to the source region or the drain region at a voltage selected over the range of −20 V to 20 V.

15. The sensor of claim 1, wherein the fluid gate electrode comprises Pt, Ag, Ag/Cl or any combination of these.

16. The sensor of claim 1, wherein the fluid gate electrode is biased relative to the source region or the drain region at a voltage selected over the range of −20 V to 20 V.

17. The sensor of claim 1, wherein the sensor comprises a nanowire, a nanoplate or both a nanowire and a nanoplate.

18. A chemical sensor array comprising:
a plurality of sensors, wherein each of said sensors independently comprises:
a source region,
a drain region,
a channel region positioned between the source and drain regions,
a buried back gate positioned at least partly below the channel region;
a sensing region positioned over the channel region, the sensing region comprising a high-k dielectric layer;
a fluid positioned in contact with the sensing region; and
a fluid gate electrode positioned in contact with the fluid;
wherein the sensor is electrically stable when the fluid is in contact with the sensing region.

19. The chemical sensor array of claim 18, wherein each of the plurality of sensors are independently electrically addressable.

20. The chemical sensor array of claim 18, wherein each of the plurality of sensors are independently fluidly addressable.

21. A method of sensing a compound, the method comprising the steps of:
providing a sensor comprising:
a source region,
a drain region,
a channel region positioned between the source and drain regions,
a buried back gate positioned at least partly below the channel region;
a sensing region positioned over the channel region, the sensing region comprising a high-k dielectric layer;
a fluid positioned in contact with the sensing region; and
a fluid gate electrode positioned in contact with the fluid;
wherein the sensor is electrically stable when the fluid is in contact with the sensing region;
monitoring an electrical property of the channel region;
providing the compound to the fluid; and
determining a change in the electrical property of the channel region due to the presence of the compound in the fluid, thereby sensing the compound.

22. A lab-on-a-chip device comprising:
a sensor comprising:
a source region,
a drain region,
a channel region positioned between the source and drain regions,
a buried back gate positioned at least partly below the channel region;
a sensing region positioned over the channel region, the sensing region comprising a high-k dielectric layer;
a fluid positioned in contact with the sensing region; and
a fluid gate electrode positioned in contact with the fluid;
wherein the sensor is electrically stable when the fluid is in contact with the sensing region; and
one or more sensing, amplifying, heating or concentrating regions positioned in fluid communication with the sensor.

23. A method of making a chemical sensor, the method comprising the steps of:
providing a semiconductor wafer, wherein the semiconductor wafer comprises a semiconductor substrate layer, a buried oxide layer and a superficial semiconductor layer, wherein the buried oxide layer is positioned between the semiconductor substrate layer and the superficial semiconductor layer;
masking at least a portion of the superficial semiconductor layer with a first mask;
etching at least a portion of the superficial semiconductor layer, thereby forming an etched semiconductor layer;
removing the first mask;
masking at least a portion of the etched semiconductor layer with a second mask;
implanting at least a portion of the etched semiconductor layer with dopants, thereby creating doped source and drain regions and undoped channel regions in the etched semiconductor layer; and
depositing a high-k dielectric layer over the channel regions using atomic layer deposition.

24. The method of claim 23, further comprising the steps of:
patterning electrodes in independent electrical communication with each source and drain region;
depositing a dielectric passivation layer over at least a portion of the high-k dielectric layer and over at least a portion of the electrodes; and
etching a portion of the dielectric passivation layer to expose a portion of the high-k dielectric layer.
